(19) United States
(12) Patent Application Publication
(10) Pub. No.: US 2005/0019646 A1
(43) Pub. Date: Jan. 27, 2005

(54) Complementary active-surface feed flow

(76) Inventor: Nathaniel Ian Joos, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/845,263

(22) Filed: May 14, 2004

Related U.S. Application Data
(60) Provisional application No. 60/470,869, filed on May 16, 2003.

(51) Int. Cl. H01M 8/02; H01M 8/04

(52) U.S. Cl. 429/38; 429/26

(57) ABSTRACT

The present invention relates to the design of flow field plates suited for use in electrochemical cells. According to aspects of some embodiments of the invention a true single plate bipolar flow field plate is provided. Moreover, according to other aspects of some embodiments of the invention active surfaces corresponding to an anode and a cathode, respectively, are substantially identical to one another, whereas in other embodiments the respective active surfaces are identical to one another after a transformation such as a reflection or 180 degree rotation.

### PRIORITY CLAIM

This application claims the benefit of U.S. Provisional Application No. 60/470,869, filed May 16, 2003, and the entire contents of which are hereby incorporated by reference.

### FIELD OF THE INVENTION

The present invention relates to electrochemical cells, and, in particular to the design of flow field plates suited for use in electrochemical cells.

### BACKGROUND OF THE INVENTION

An electrochemical cell, as defined herein, is an electrochemical reactor that may be configured as either a fuel cell or an electrolysis (i.e. electrolyzer) cell. In practice a number of electrochemical cells, all of one type, can be arranged in stacks having common features, such as process gas/fluid feeds, drainage, electrical connections and regulation devices. Both types of electrochemical cells include anode and cathode electrodes sometimes in the form of flow field plates. A membrane, or another solid electrolyte carrier, is sandwiched between the two electrodes. Catalyst layers are generally applied to an interface between each electrode and the membrane. In the following description, it is to be understood that the designations “front surface” and “rear surface” with respect to both anode and cathode electrodes in the form of flow field plates indicates the orientation of a particular flow field plate with respect to the membrane. Thus, the “front surface” indicates an active surface facing the membrane, whereas, the “rear surface” indicates a non-active surface facing away from the membrane.

Process gases/fluids (including both reactants and products) are supplied to and evacuated from the surface of a membrane via a flow field structure arranged within an active area on the front surface of a particular flow field plate. To ensure reliable operation the process gases/fluids of the anode flow field plate must be kept separate from those of the cathode flow field plate. Moreover, it is desirable to spread the reactant process gases/fluids as uniformly as possible over the active area so that the membrane surface area is used efficiently. Typically, these requirements are met by an arrangement for the flow field structure that includes a flow channel pattern for effectively sealing and distributing gases/fluids over the active area. Optionally, in some electrochemical cells coolant channels are provided on the rear surface of some of the flow field plates to aid in heat dissipation.

Each flow field plate also usually includes a number of manifolds or openings. Each manifold is provided to serve as a portion of an elongate distribution channel for one of fuel, oxidant, coolant and exhaust products. The aforementioned flow field structure is appropriately fluidly connected to the manifolds by at least one, and in most cases, a number of open-faced flow channels. When an electrochemical cell stack is assembled, the manifolds of the flow field plates align to form elongate distribution channels extending perpendicular to the flow field plates.

Various designs for flow field structures are known. A commonly known serpentine-shaped flow field structure is disclosed in U.S. Pat. Nos. 4,988,583, 6,099,984 and 6,309,773. The serpentine-shaped flow field structure disclosed in these patents provides a long flow channel without increasing the dimensions of a flow field plate. However, these designs also share a number of inherent problems. Serpentine-shaped flow channels create a greater pressure drop across a flow field plate because gas/fluid distribution is not uniform in these structures. This negatively affects the performance of an electrochemical cell operating under a relatively low pressure. The gas/fluid flow is also more turbulent in a serpentine-shaped flow field structure, making it more difficult to control the flow, pressure or temperature of the reactant gases/fluids. Moreover, serpentine-shaped flow field structures provide more places for water and/or contaminants to accumulate, increasing the risk of flooding and/or poisoning an electrochemical cell.

Another problem associated with most flow field designs is that the ribs and channels that define a flow field structure on an anode flow field plate are often offset with those on a cathode flow field plate when the plates are assembled. Since pressure is often applied to the plates, a membrane between the plates is subject to shearing forces that may damage the membrane. The offset between the anode and cathode flow field structures also impedes the distribution of reactant gases/fluids across active areas of the flow field plates, thereby reducing efficiency.

A further problem is that sealing an anode from a cathode, in an electrochemical cell, is often complicated. For any one reactant gas/fluid, it is possible to provide a seal that completely encloses all of the flow field structure and the inlet and outlet manifolds for the reactant gas/fluid on a corresponding front surface of a first flow field plate (e.g. an anode). However, on the other side of the membrane, it is necessary to provide a seal that also completely encloses inlet and outlet manifolds on a second flow field plate (e.g. a cathode) that corresponds to inlet and outlet manifolds for the reactant gas/fluid on the first flow field plate. In this configuration, part of the membrane is not properly supported thereby inadequately sealing the anode from the cathode and resulting in a mixing of gases between the anode and cathode.

### SUMMARY OF THE INVENTION

According to a first aspect of an embodiment of the invention there is provided a flow field plate suited for use in an electrochemical cell having: an active surface having a first area, a second area and a third area; an active area within the first area; a first complementary active-surface feed flow aperture located within the first area, extending through the thickness of the flow field plate and fluidly connected to the active area over a portion of the first area; a first manifold within the second area; a second manifold within the third area; a second complementary active-surface feed flow aperture located within the third area, extending through the thickness of the flow field plate and fluidly connected to the second manifold over a portion of the third area, such that in use at least one of a process gas and a process fluid traverses a portion of the active surface without being introduced to the active area; and a sealing surface separating each of the first, second and third areas from one another. In related embodiments the first, second and third areas are symmetrically arranged on the active surface. In some related embodiments the active area contains a flow field structure for uniformly distributing one of the process gas and the process fluid across the active area. In some related embodiments the sealing surface includes a gasket groove.

In some embodiments the active surface also includes: a fourth area separated from the first, second and third areas by the sealing surface; a third manifold within the fourth area; and a third complementary active-surface feed flow aperture located within the first area, extending through the thickness of the flow field plate and fluidly connected to the active area over a portion of the first area. In related embodiments the active surface also has: a fifth area separated from the first, second, third and fourth areas by the sealing surface; a fourth inlet manifold within the fifth area; and a fourth complementary active-surface feed flow aperture located within the fifth area, extending through the thickness of the flow field plate and fluidly connected to the fourth manifold over a portion of the fifth area, such that in use at least one of a process gas and a process fluid traverses a portion of the active surface without being introduced to the active area. In related embodiments the first, second, third, fourth and fifth areas are symmetrically arranged on the active surface.

In some embodiments the flow field plate also includes: a rear passive surface oppositely facing the active surface, the rear passive surface having cooling channels; and an inlet coolant manifold fluidly connected to the cooling channels over a portion of the rear passive surface; an outlet coolant manifold fluidly connected to the cooling channels over a portion of the rear passive surface; and the inlet and outlet coolant manifolds separated from each other and the first, second and third areas by the sealing surface on the active surface of the flow field plate.

In some embodiments the active surface also includes: a fourth area separated from the first, second and third areas by the sealing surface; a third manifold within the fourth area; and a third complementary active-surface feed flow aperture located within the fourth area, extending through the thickness of the flow field plate and fluidly connected to the third manifold over a portion of the fourth area, such that in use at least one of a process gas and a process fluid traverses a portion of the active surface without being introduced to the active area.

In some related embodiments the first, second, third and fourth manifolds are designated as an anode inlet manifold, a cathode inlet manifold, an anode outlet manifold and a cathode outlet manifold, respectively.

In some related embodiments the anode inlet manifold is larger than the cathode inlet manifold. Alternatively, in other embodiments the cathode inlet manifold is larger than the anode inlet manifold. Moreover, in some embodiments anode outlet manifold is larger than the cathode outlet manifold. Alternatively, in other each manifold has a unique size.

In some related embodiments the first, second, third and fourth manifolds are designated as a cathode inlet manifold, an anode inlet manifold, a cathode outlet manifold and an anode outlet manifold, respectively.

According to an aspect of another embodiment of the invention there is provided an electrochemical cell stack that includes: two adjacent electrochemical cells; the two electrochemical cells co-operatively sharing a bipolar flow field plate having a first active surface and a second active surface, the first active surface serving as an anode for one of the two adjacent electrochemical cells and the second active surface serving a cathode for the other of the two adjacent electrochemical cells, and each active surface having a respective active area; the bipolar flow field plate having a first manifold; and the bipolar flow field plate having a first complementary active-surface feed flow aperture extending through the thickness of the bipolar flow field plate, fluidly connected to the first manifold over a portion of the second active surface and fluidly connected to the active area of the first active surface over a portion of the first active surface, such that in use at least one of a process gas and a process fluid, traveling to or from the active area of the first active surface, traverses a portion of the second active surface without being introduced to the active area of the second active surface.

In some embodiments the bipolar flow field plate also has: a second manifold; and a second complementary active-surface feed flow aperture extending through the thickness of the bipolar flow field plate, fluidly connected to the second manifold over a portion of the first active surface and fluidly connected to the active area of the first active surface over a portion of the first active surface, such that in use at least one of a process gas and a process fluid, traveling to or from the active area of the second active surface, traverses a portion of the first active surface without being introduced to the active area of the first active surface.

In some embodiments the bipolar flow field plate is comprised of two separate plates that have been brought together so as to align back-to-back, the two separate plates manufactured such that the first active surface is on one plate and the second active surface is on the other plate.

According to another aspect of an embodiment of the invention there is provided a bipolar flow field plate suited for use in an electrochemical cell that has: a first active surface having first, second and third areas that are each separated from one another by a first sealing surface; a second active surface, oppositely facing the first active surface, having fourth, fifth and six areas that are each separated from one another by a second sealing surface; a first active area within the first area; a second active area within the fourth area; a first manifold extending through the bipolar flow field plate from the second area to the fifth area; a second manifold extending through the bipolar flow field plate from the third area to the sixth area; a first complementary active-surface feed flow aperture extending through the bipolar flow field plate from the first area to the fifth area, fluidly connected to the first manifold over a portion of the fifth area and fluidly connected to the first active area over a portion of the first area; and a second complementary active-surface feed flow aperture extending through the bipolar flow field plate from the third area to the fourth area, fluidly connected to the second manifold over a portion of the third area and fluidly connected to the second active area over a portion of the fourth area. In related embodiments the first, second and third areas are arranged on the first active surface so that they correspond to a mirror image arrangement of the fourth, fifth and sixth areas, respectively, such that features present in the first, second and third areas also correspond to mirror images of features in the fourth, fifth and sixth areas, respectively.

In some embodiments the bipolar flow field plate also includes: a seventh area on the first active surface separated from the first, second and third areas by the first sealing surface; an eighth area on the second active surface separated from the fourth, fifth, and sixth areas by the second sealing surface; a third manifold extending through the bipolar flow field plate from the seventh area to the eighth area; and a third complementary active-surface feed flow aperture extending through the bipolar flow field plate from the first area to the eighth area, fluidly connected to the third manifold over a portion of the eighth area and fluidly connected to the first active area over a portion of the first area. In related embodiments the first, second, third and seventh areas are arranged on the first active surface so that they correspond to a mirror image arrangement of the fourth, fifth, sixth and eighth areas, respectively, such that features present in the first, second, third and seventh areas also correspond to mirror images of features in the fourth, fifth, sixth and eighth areas, respectively.

In some embodiments the bipolar flow field plate also includes: a ninth area on the first active surface separated from the first, second, third and seventh areas by the first sealing surface; a tenth area on the second active surface separated from the fourth, fifth, sixth, and eighth areas by the second sealing surface; a fourth manifold extending through the bipolar flow field plate from the ninth area to the tenth area; and a fourth complementary active-surface feed flow aperture extending through the bipolar flow field plate from the fourth area to the ninth area, fluidly connected to the fourth manifold over a portion of the ninth area and fluidly connected to the second active area over a portion of the fourth area. In related embodiments the first, second, third, seventh and ninth areas are arranged on the first active surface so that they correspond to a mirror image arrangement of the fourth, fifth, sixth, eighth and tenth areas, respectively, such that features present in the first, second, third, seventh and ninth areas also correspond to mirror images of features in the fourth, fifth, sixth, eighth and tenth areas respectively.

In some embodiments the first, second, third, seventh and ninth areas are arranged on the first active surface so that they correspond to a 180 degree rotated image arrangement of the fourth, tenth, eighth, sixth and fifth areas, respectively, such that features present in the first, second, third, seventh and ninth areas also correspond to images of features in the fourth, tenth, eighth, sixth and fifth areas, respectively, that have been rotated 180 degrees.

In some embodiments the first active surface and the second active surface are on oppositely facing surfaces of a single plate.

In some embodiments the first active surface is located on a first plate and the second active surface is located on a second plate and the first and second plates are connectable so that the first and second active surfaces face opposite directions. In some related embodiments a bipolar flow field plate also includes: an inlet coolant manifold extending through both of the first and second plates; an outlet coolant manifold extending through both of the first and second plates, wherein the inlet and outlet coolant manifolds are separated from each other and the first, second and third areas by the first sealing surface on the first active surface located on the first plate, and the inlet and outlet coolant manifolds are separated from each other and the fourth, fifth and sixth areas by the second sealing surface on the second active surface located on the second plate; and at least one of the first and second plates further comprises a rear passive surface oppositely facing the respective first or second active surface, the rear passive surface having cooling channels that are fluidly connected to the inlet and outlet coolant manifolds over respective portions of the rear passive surface.

In some embodiments flow field structures included on the first and second active areas are substantially identical, whereas in other embodiments this is not the case.

In some embodiments the first, second and third areas are symmetrically arranged on the first active surface, and the fourth, fifth and sixth areas are symmetrically arranged on the second active surface.

In some embodiments the first, second, third, seventh and ninth areas are symmetrically arranged on the first active surface, and the fourth, fifth, sixth, eighth and tenth areas are symmetrically arranged on the second active surface.

According to a first aspect of an embodiment of the invention there is provided a single manufacturing mask suitable for manufacturing both an active surface of an anode flow field plate and an active surface of a cathode flow field plate and two active surfaces of a bipolar flow field plate, the single manufacturing mask having features for defining: a first area having an active area; a second area having a first manifold; a third area having a second manifold; and a sealing surface separating the first, second and third areas from one another; wherein the first, second and third areas are symmetrically arranged on the active surface. In some related embodiments the sealing surface includes a gasket groove.

In some embodiments the single manufacturing mask further includes features for defining: a first complementary active-surface feed flow aperture fluidly connected to the first manifold over a portion of the third area; and a second complementary active-surface feed flow aperture, within the first area and fluidly connected to the active area over a portion of the first area.

In some embodiments the single manufacturing mask further includes features for defining: a fourth area having a third manifold; and a fifth area having a fourth manifold; wherein the first, second, third, fourth and fifth areas are separated by the sealing surface; and wherein the first, second, third, fourth and fifth areas are arranged so that they correspond to a 180 degree rotated image arrangement of the first, third, second, fifth and fourth areas, respectively, such that features present in the first, second, third, fourth and fifth areas also correspond to images of features in the first, third, second, fifth and fourth areas, respectively, that have been rotated 180 degrees. In related embodiments the single manufacturing mask further includes features for defining: a third complementary active-surface feed flow aperture fluidly connected to the third manifold over a portion of the fourth area; and a fourth complementary active-surface feed flow aperture, within the first area, fluidly connected to the active area over a portion of the first area.

In some embodiments the single manufacturing mask further includes features for defining: an inlet coolant manifold; and an outlet coolant manifold; wherein the sealing surface is extended to separate the inlet and outlet coolant manifolds from one another and the first, second and third areas. In some related embodiments there is provided a second manufacturing mask corresponding to a single manufacturing mask, wherein the second manufacturing mask is suitable for producing a oppositely facing non-active surface for both an anode and a cathode flow field plate, the second mask including features for defining coolant channels fluidly connected to the inlet coolant manifold and the outlet coolant manifold.

In some embodiments the single manufacturing mask further includes features for defining: a first back-side feed flow aperture, within the first area and fluidly connected to the active area over a portion of the first area; and a second back-side feed flow aperture, within the first area and fluidly connected to the active area over a portion of the first area.

Other aspects and features of the present invention will become apparent, to those ordinarily skilled in the art, upon review of the following description of the specific embodiments of the invention.

### BRIEF DESCRIPTION OF THE DRAWING FIGURES

For a better understanding of the present invention, and to show more clearly how it may be carried into effect, reference will now be made, by way of example, to the accompanying drawings, which illustrate aspects of embodiments of the present invention and in which:

FIG. 1A is an illustration of an assembled perspective view of an electrochemical cell stack according to aspects of a first embodiment of the invention;

FIG. 1B is an illustration of an assembled perspective view of an electrochemical cell stack according to aspects of a second embodiment of the invention;

FIG. 2A is an illustration of an exploded perspective view of the electrochemical cell stack shown in FIG. 1A;

FIG. 2B is an illustration of an exploded perspective view of the electrochemical cell stack shown in FIG. 1B;

FIG. 3A is a schematic drawing of a first active surface of a first bipolar flow field plate suited for use in the electrochemical cell stack shown in FIG. 1A;

FIG. 3B is a schematic drawing of a first active surface of a second bipolar flow field plate suited for use in the electrochemical cell stack shown in FIG. 1B;

FIG. 4A is a schematic drawing of a second active surface of the first bipolar flow field plate shown in FIG. 3A;

FIG. 4B is a schematic drawing of a second active surface of the second bipolar flow field plate shown in FIG. 3B;

FIG. 5A is a schematic drawing of a first active surface of a third bipolar flow field plate suited for use in the electrochemical cell stack shown in FIG. 1A;

FIG. 5B is a schematic drawing of a first active surface of a fourth bipolar flow field plate suited for use in the electrochemical cell stack shown in FIG. 1B;

FIG. 6A is a schematic drawing of a second active surface of the third bipolar flow field plate shown in FIG. 5A;

FIG. 6B is a schematic drawing of a second active surface of the fourth bipolar flow field plate shown in FIG. 5B;

FIG. 7A is a schematic drawing of a gasket suited for use on both active surfaces of the bipolar flow field plates shown in FIGS. 3A, 4A, 5A and 6A;

FIG. 7B is a schematic drawing of a gasket suited for use on both active surfaces of the bipolar flow field plates shown in FIGS. 3B, 4B, 5B and 6B;

FIG. 8A is an illustration of a first step in an example assembly procedure for flow field plates suited for use the electrochemical cell stack shown in FIG. 1B;

FIG. 8B is an illustration of a second step in the example assembly procedure, continuing from FIG. 8A;

FIG. 8C is an illustration of a third step of the example assembly procedure continuing from FIG. 8B;

FIG. 9A is a schematic drawing of a front (active) surface of a first flow field plate suited for use in the electrochemical cell stack shown in FIG. 1A;

FIG. 9B is a schematic drawing of a rear (passive/cooling) surface of the first flow field plate shown in FIG. 9A;

FIG. 9C is a schematic drawing of a front (active) surface of a second flow field plate suited for use in the electrochemical cell stack shown in FIG. 1A;

FIG. 9D is a schematic drawing of a rear (passive/cooling) surface of the second flow field plate shown in FIG. 9C;

FIG. 10A is a schematic drawing of a front (active) surface of a third flow field plate suited for use in the electrochemical cell stack shown in FIG. 1A;

FIG. 10B is a schematic drawing of a rear (passive/cooling) surface of the third flow field plate shown in FIG. 10A;

FIG. 10C is a schematic drawing of a front (active) surface of a fourth flow field plate suited for use in the electrochemical cell stack shown in FIG. 1A; and

FIG. 10D is a schematic drawing of a rear (passive/cooling) surface of the fourth flow field plate shown in FIG. 10C.

### DETAILED DESCRIPTION OF PREFERRED EMBODIMENTS

Aspects of the flow field structure and plate arrangement according to embodiments described in the applicant's co-pending U.S. patent application Ser. No. 10/109,002 (filed 29 Mar. 2002) can be employed to provide reduced shearing forces on a membrane and simplify sealing between flow field plates. The entire contents of the applicant's co-pending U.S. patent application Ser. No. 10/109,002 are hereby incorporated by reference. An anode flow field plate includes a number of anode flow field channels defined by ribs (i.e. an anode flow field structure). Similarly, a cathode flow field plate includes a number of cathode flow field channels defined by ribs (i.e. a cathode flow field structure). After assembly, a substantial portion of the anode flow field channels and the cathode flow field channels are disposed directly opposite one another with a membrane placed there-between. Accordingly, a substantial portion of the ribs of the anode flow field plate match-up with a corresponding substantial portion of the ribs on the cathode flow field plate. This is described as “rib-to-rib” pattern matching hereinafter.

Additionally, aspects of flow field plate arrangement according to embodiments described in the applicant's co-pending U.S. patent application Ser. No. 09/855,018 (filed 15-May-2001) can also be employed to provide an effective sealing between flow field plates and a membrane placed there-between. The entire contents of the applicant's co-pending U.S. patent application Ser. No. 09/855,018 are hereby incorporated by reference. In this arrangement, the inlet flow of a particular process gas/fluid from a respective manifold does not take place directly over the front (active) surface of a flow field plate; rather, the process gas/fluid is first guided from the respective manifold over a portion of the rear (passive) surface of the flow field plate and then through a “back-side feed” aperture extending from the rear surface to the front surface. A portion of the front surface defines an active area that is sealingly separated from the respective manifold over the front surface when an electrochemical cell stack is assembled. The portion of the rear surface over which the inlet flow of the process gas/fluid takes place has open-faced gas/fluid flow field channels in fluid communication with the respective manifold. The back-side feed apertures extend from the rear surface to the front surface to provide fluid communication between active area and the open-faced gas/fluid flow field channels that are in fluid communication with the respective manifold. The back-side feed apertures are arranged on the front surface of the flow field plate away from the active area where the flow field plate contacts the membrane. In this way, for example, the seal between the membrane and the flow field plate is made in an unbroken path around the periphery of the membrane. In prior art examples, the seal between the membrane and the active area on the front surface of the flow field plate, which is typically around the periphery of the membrane is broken by the open-faced flow field channels leading up to respective manifold from the active area on the front surface of the flow field plate. By contrast, according to the applicant's aforementioned co-pending application a process gas/fluid is fed to the active area on the front surface through back-side feed apertures from the rear surface of each flow field plate, where a seal is made around the back-side feed apertures and the respective manifold. This method of flowing fluids from a rear (passive or non-active) surface to the front (active) surface is referred to as “back-side feed” in the description. Those skilled in the art would appreciate that gases/fluids can be evacuated from the active area on the front surface to the rear surface and then into another respective manifold in a similar manner.

Nevertheless, the flow field plate structures and membrane assemblies used thus far are fairly complex structures that require highly skilled workers for the assembly of electrochemical cell stacks. For example, the different versions of flow field plates (anode or cathode) have to be chosen in a proper sequence and placed in a correct orientation. The flow field plates are also quite costly to manufacture since at least three different manufacturing masks are required to create all of the necessary plates and surfaces employed within an electrochemical cell. Therefore, there remains a need for a flow field plate arrangement that enables simplified manufacturing and assembly of electrochemical cell stacks, whilst continuing to provide the advantages listed above related to “back-side feed” and “rib-to-rib” pattern matching between anode and cathode flow field plates sandwiching a membrane.

According to aspects of various embodiments of the present invention there is provided a flow field structure and plate arrangement that provides the advantages listed above related to “back-side feed” and “rib-to-rib” pattern matching, and, additionally simplifies manufacturing and assembly of flow field plates into an electrochemical cell stack. In particular, flow field plates can be produced with only one mask and a true single plate bipolar flow field plate design is possible according to aspects of some embodiments of the invention. Those of skill in the art would appreciate that a manufacturing mask may be substituted with a die or a mold or any other suitable manufacturing apparatus and method usable to impart or form physical features onto a surface. The exact apparatus and method of manufacturing plates will, in some embodiments, depend on the type of material used to produce the plates. Stamping, molding, casting, milling and etching are each examples of manufacturing processes that can be used alone or in a suitable combination to produce flow field plates.

Flow field plates typically include a number of manifolds that each serve as a portion of a corresponding elongate distribution channel for a particular process gas/fluid. In some embodiments, the cathode of an electrolyzer cell does not need to be supplied with an input process gas/fluid and only hydrogen gas and water need to be evacuated. In such electrolyzer cells a flow field plate does not require an input manifold for the cathode but does require an output manifold. By contrast, a typical embodiment of a fuel cell makes use of inlet and outlet manifolds for both the anode and the cathode. However, fuel cells can also be operated in a dead-end mode in which process reactants are supplied to a fuel cell but not circulated away from the fuel cell. In such embodiments, only inlet manifolds for process reactants are provided.

Generally, it is possible to have multiple inlet and outlet manifolds on a flow field plate for each reactant gas/fluid, coolant, and exhaust product depending on the fuel cell or electrolyzer cell design.

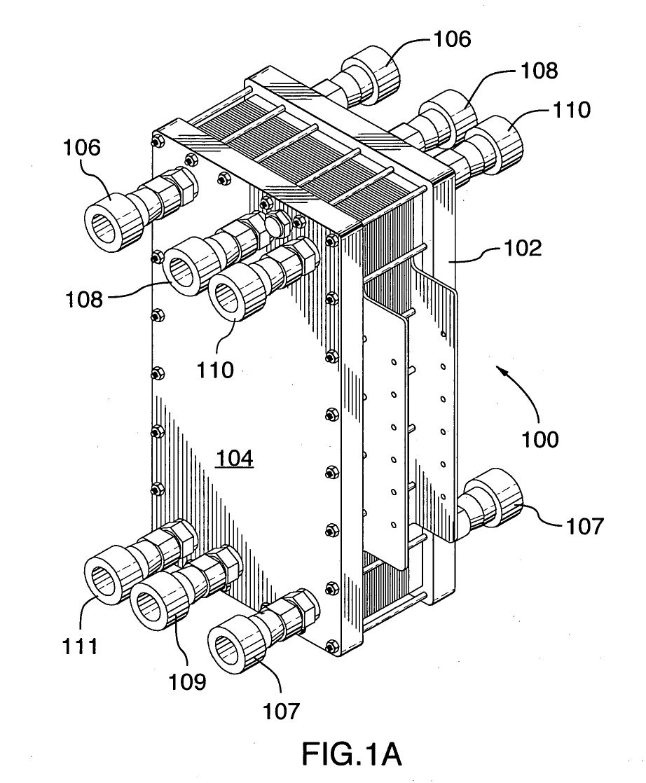

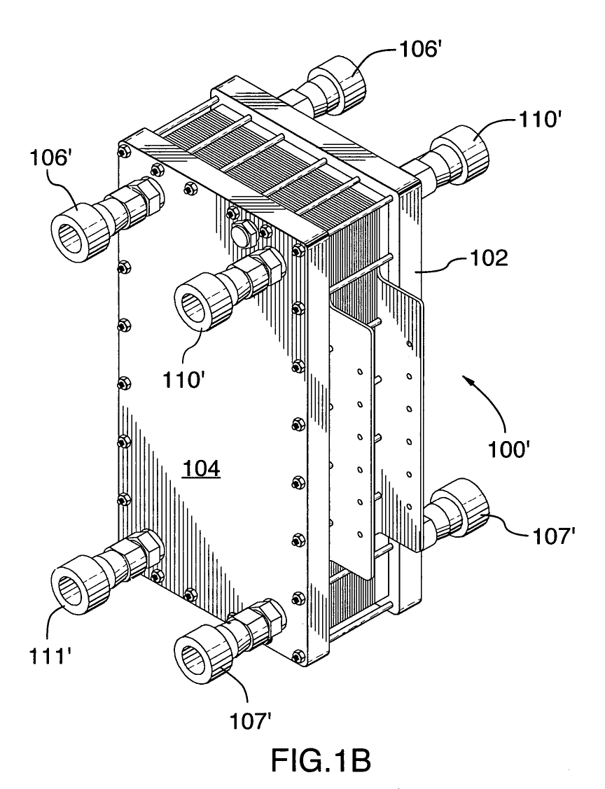

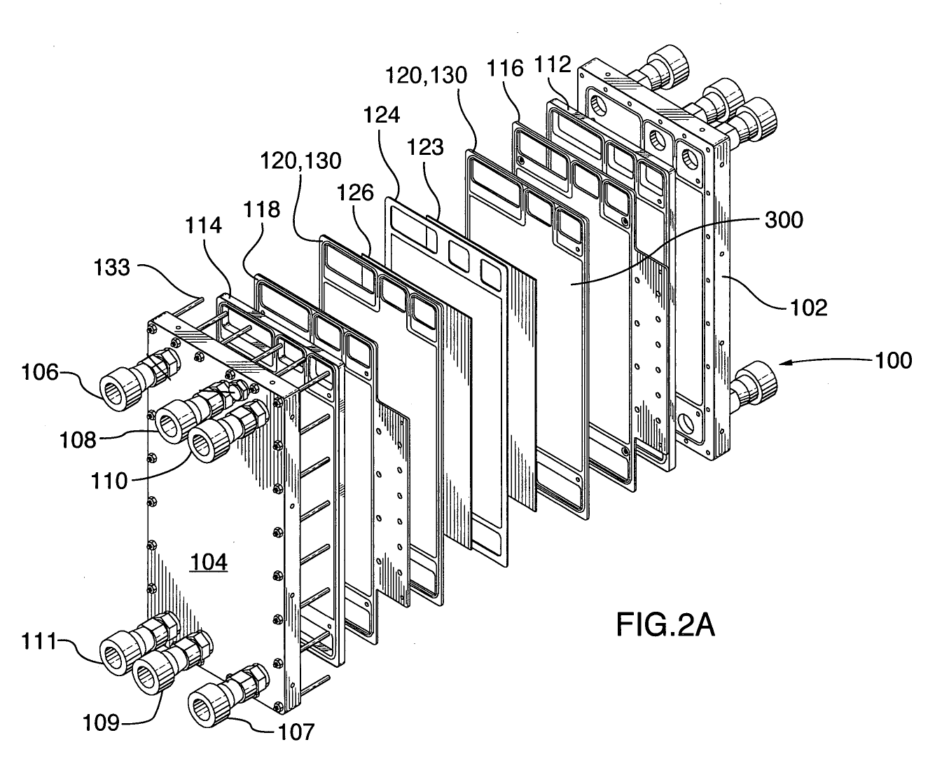

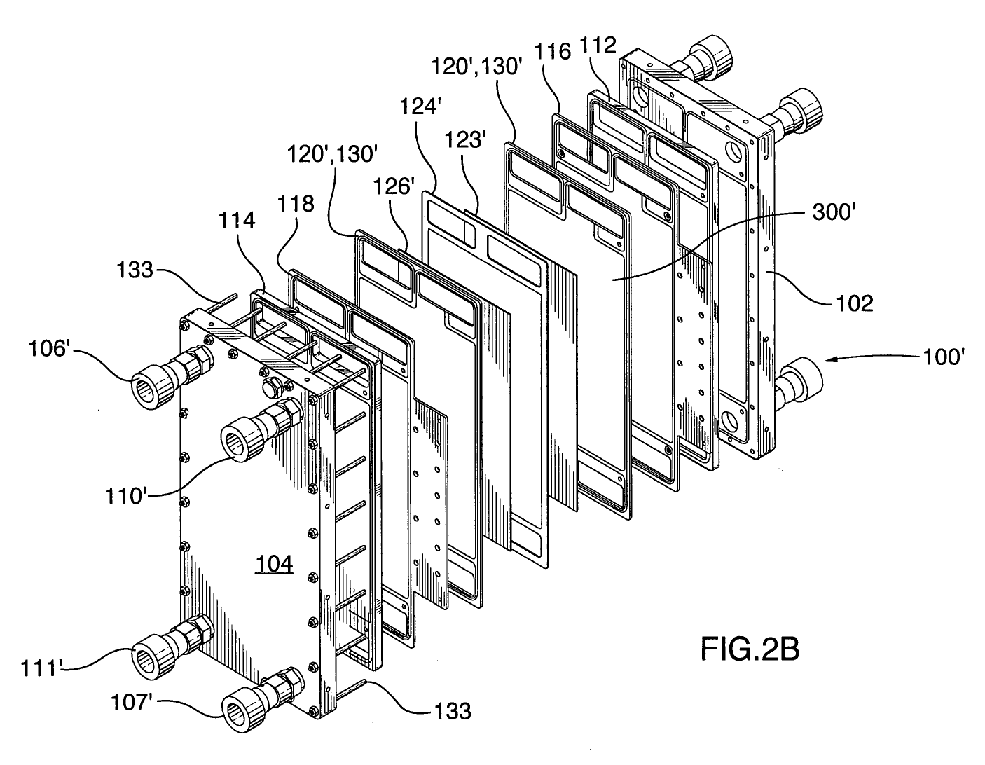

An assembled perspective view of an electrochemical cell stack 100 in accordance with aspects of a first embodiment of the invention is shown in FIG. 1A; and a corresponding exploded perspective view of the electrochemical cell stack 100 is shown in FIG. 2A. Similarly an assembled perspective view of an electrochemical cell stack 100′ in accordance with aspects of a second embodiment of the invention is shown in FIG. 1B; and a corresponding exploded perspective view of the electrochemical cell stack 100′ is shown in FIG. 2B. Common elements and features that do not substantially impact the aspects of embodiments of the present invention and that are substantially the same for both electrochemical cell stacks 100 and 100′ have been designated using the same reference numbers in FIGS. 1A, 1B, 2A and 2B.

With continued reference to FIGS. 1A, 1B, 2A and 2B, the electrochemical cell stacks 100 and 100′ both include an anode endplate 102 and a cathode endplate 104. The remaining elements of each electrochemical cell stack 100, 100′ are interposed between the endplates 102, 104. The endplates 102, 104 are provided with connection ports for supply and removal of process gases/fluids. The connection ports provided to each electrochemical cell stack 100 and 100′ will be described in greater detail below. However, it is to be appreciated by those skilled in the art that various arrangements of connection ports may be provided in different embodiments of the invention.

Elements interposed between the anode and cathode endplates 102, 104 include an anode insulator plate 112, an anode current collector 116, a cathode current collector 118 and a cathode insulator plate 114. In different embodiments varying numbers of electrochemical cells are arranged between the current collector plates 116 and 118. In such embodiments the elements that make up each electrochemical cell are appropriately repeated in sequence to provide an electrochemical cell stack that produces the desired output. For the sake of brevity and simplicity, only the elements of one electrochemical cell are shown in FIGS. 1A, 1B, 2A and 2B.

In order to hold each of the electrochemical cell stacks 100, 100′ together tie rods 133 are provided that are screwed into threaded bores in the anode endplate 102 (or otherwise fastened), passing through corresponding plain bores in the cathode endplate 104. Nuts and washers or other fastening means are provided, for tightening the whole assembly and to ensure that the various elements of the individual electrochemical cells 100 and 100′ are held together tightly.

As mentioned above various connection ports to an electrochemical cell stack are included to provide a means for supplying and evacuating process gases, fluids, coolants etc. In some embodiments the various connection ports to an electrochemical cell stack are provided in pairs. One of each pair of connection ports is arranged on a cathode endplate (e.g. cathode endplate 104) and the other is appropriately placed on an anode endplate (e.g. anode endplate 102). In other embodiments, an electrochemical cell stack is dead-ended and the various connection ports are only placed on either the anode or cathode endplate. For both electrochemical cell stacks 100 and 100′, various connection ports are provided in pairs.

With specific reference to the cathode endplate 104 shown FIGS. 1A and 2A: water connection ports are indicated at 106, 111; oxygen/water exhaust connection ports are indicated at 107, 110; and, hydrogen exhaust connection ports are indicated at 108, 109. Although not shown, it is to be understood that connection ports, corresponding to connection ports 109, 111 are also provided on the anode endplate 102. The various connection ports 106-111 are connected to elongate distribution channels or ducts that extend through the electrochemical stack 100, which will be described in greater detail below.

With specific reference to the cathode endplate 104 shown in FIGS. 1B and 2B: hydrogen connection ports are indicated at 106′, 107′; and, air/water connection ports are indicated at 110′, 111′. Although not shown, it is to be understood that a connection port, corresponding to connection port 111′ is also provided on the anode endplate 102. The various connection ports 106′, 107′, 110′, 111′ are connected to elongate distribution channels or ducts that extend through the electrochemical cell stack 100′, which will be described in greater detail below.

It was also noted above that a number of electrochemical cells are disposed between the current collector plates 116 and 118. Generally, each electrochemical cell is made up of anode flow field plate, a cathode flow field plate and a membrane (or membrane assembly) disposed there-between. In some embodiments of the present invention, the front surfaces of the anode and the cathode flow field plates are substantially identical, while in other embodiments the respective front surfaces are mirror images or rotations of one another. Alternatively, in other embodiments the front surfaces are substantially different from one another. A gas diffusion layer or media is also typically placed between each flow field plate and the membrane. Alternatively, in other embodiments a gas diffusion layer is suitably integrated into a membrane assembly.

With specific reference to the electrochemical cell stack 100 of FIG. 2A, as is illustrated for example only, an electrochemical cell is made up of a first (anode) flow field plate 120, 130 an anode gas diffusion layer or media 123, a membrane electrode assembly (MEA) 124, a cathode gas diffusion layer 126 and a second (cathode) flow field plate 120, 130. Gaskets 300 are sealingly arranged on either side of the flow field plates 120, 130, to keep the different process gas/fluid flows separate from one another along sealing surfaces on the flow field plates. The shape of each of the gaskets 300 conforms to the particular shape of the flow field plate it is used to seal.

With specific reference to the electrochemical stack 100′ of FIG. 2B, as illustrated for example, an electrochemical cell is made up of a first (anode) flow field plate 120′, 130′ an anode gas diffusion layer or media 123′, a membrane electrode assembly (MEA) 124, a cathode gas diffusion layer 126′ and a second (plate) flow field plate 120′, 130′. Again, gaskets 300′ are sealingly arranged on either side of the flow field plates 120′, 130′, to keep the different process gas/fluid flows separate from one another. The shape of each of the gaskets 300′ conforms to the shape of the particular flow field plate it is used to seal.

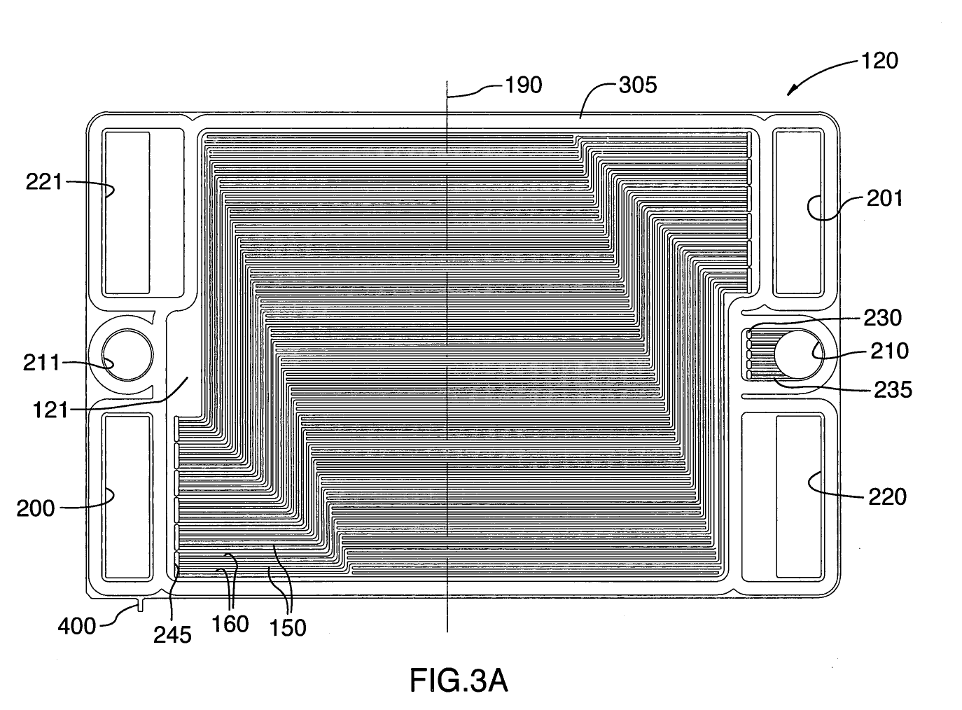

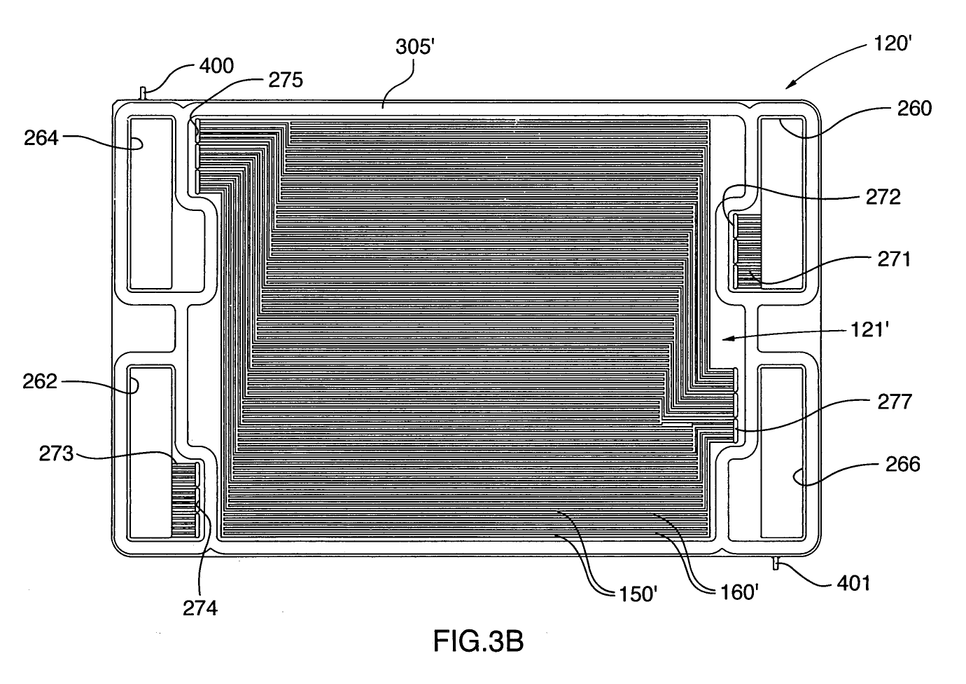

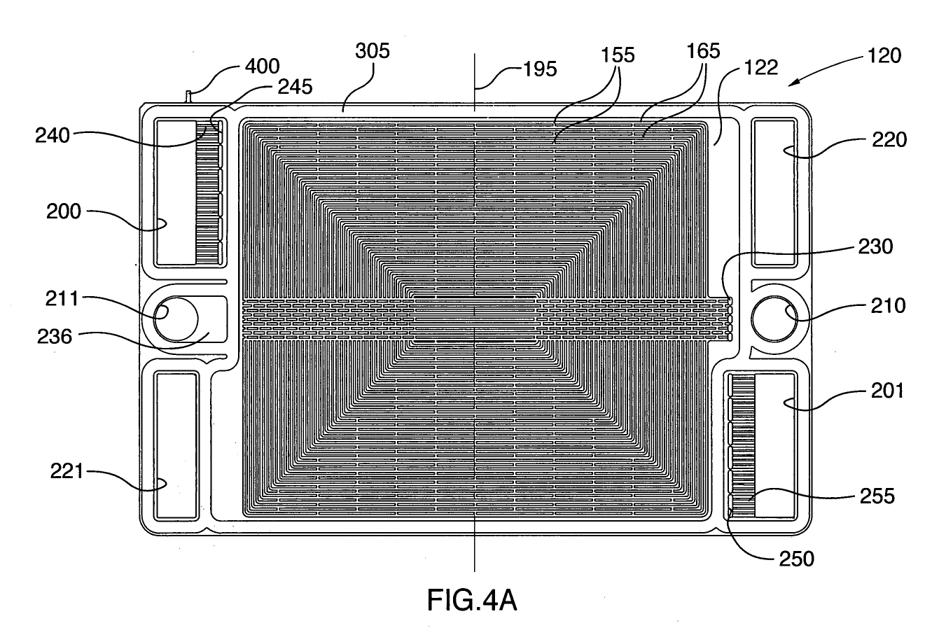

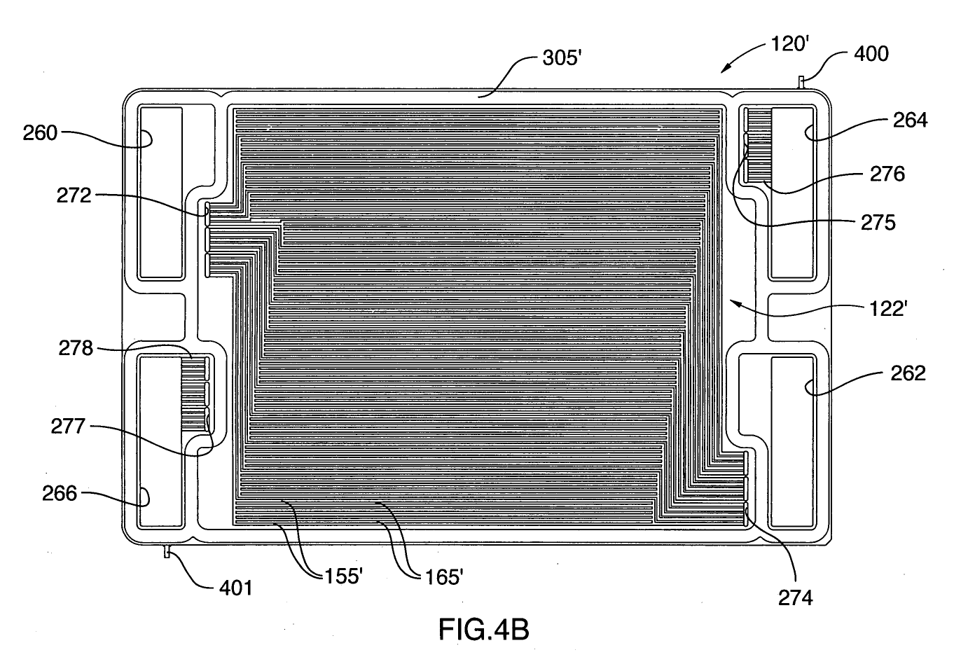

With reference to FIGS. 3A and 4A, shown are two active sides of a first bipolar flow field plate 120 that is suited for use in the electrochemical cell stack 100 shown in FIG. 1A. The bipolar flow field plate 120 has two active surfaces so that it may be employed as both an anode and a cathode simultaneously. Specifically, illustrated in FIG. 3A is a first active surface 121 of the first bipolar flow field plate 120; and illustrated in FIG. 4A is a second active surface 122 of the first bipolar flow field plate 120.

Referring to FIG. 3A, the first bipolar flow field plate 120, on its first active surface 121 includes a flow field structure in an active area that is made up of a number of primary channels 150 defined by a number of ribs 160. In some embodiments the flow field structure is arranged in a pattern that increases exposure between the process gases/fluids in the primary channels 150 and the MEA 124 of FIG. 2A.

Referring to FIG. 4A, the first bipolar flow field plate 120, on its second active surface 122 includes a flow field structure in an active area that is made up of a number of primary channels 155 defined by a number of ribs 165. In some embodiments the flow field structure is arranged in a pattern that increases exposure between the process gases/fluids in the primary channels 165 and the MEA 124 of FIG. 2A.

With reference to both FIGS. 3A and 4A, the first bipolar flow field plate 120 includes a number of manifolds or openings for process gas/fluid flow. A water in-flow manifold 201 is provided for supplying water to the first active surface 121. A water/oxygen exit manifold 200 is provided for evacuating water/oxygen from the first active surface 121. A hydrogen out-flow manifold 210 is provided for evacuating hydrogen from the second active surface 122. A hydrogen through manifold 211, water/oxygen through manifold 220 and a water through manifold 221 are provided for directing corresponding process gases/fluids to/from other flow field plates of an electrochemical cell. With further reference to FIGS. 1A and 2A, the manifolds 200, 201, 210, 211, 220 and 221 are all in fluid communication with respective process gas/fluid connection ports 106, 107, 108, 109, 110, 111 when the electrochemical cell stack 100 is assembled.

Further, on the first active surface 121, the first flow field plate 120 has hydrogen complementary active-surface feed flow apertures 230 in fluid communication with open-faced hydrogen exit channels 235. The channels 235 connect the hydrogen complementary active-surface feed flow apertures 230 to the hydrogen out-flow manifold 210. The hydrogen complementary active-surface feed flow apertures 230 thus fluidly connect the second active surface 122 of the first bipolar flow field plate 120 to the hydrogen out-flow manifold 210.

Similarly, on the second active surface 122, the first bipolar flow field plate 120 has open-faced water in-flow channels 255 that are in fluid communication with the water in-flow manifold 201. The channels 255 are fluidly connected to water complementary active-surface feed flow apertures 250 that extend from the second active surface 122 to the first active surface 121, where they are in fluid communication with the primary channels 150. The complementary active-surface feed flow apertures 250 thus fluidly connect the primary channels 150 within the active area on the first active surface 121 to the water in-flow manifold 201. Also on the second active surface 122, the first flow field plate 120 has open-faced water out-flow channels 240 in fluid communication with water out-flow manifold 200. The channels 240 are fluidly connected to water complementary active-surface feed flow apertures 245 that extend from the second active surface 122 to the first active surface 121, where they are in fluid communication with the primary channels 150. The complementary active-surface feed flow apertures 245 thus fluidly connect the primary channels 150 within the active area on the first active surface 121 to the water out-flow manifold 200.

In operation incoming water is communicated from the water in-flow manifold 201 via the water in-flow channels 255 arranged on the second active surface 122 and then through the complementary active-surface feed flow apertures 250 to the first active surface 121. Outgoing water and oxygen is communicated to the water/oxygen out-flow manifold 200 from the first active surface 121 via water/oxygen complementary active-surface feed flow apertures 245, which are in fluid communication with water/oxygen out-flow channels 240 arranged on the second active surface 122.

The fluid connections to the various manifolds via the corresponding complementary active-surface feed flow apertures follows the basic principles of back-side feed as described earlier. However, both sides of the bipolar flow field plate have active surfaces, thus, establishing a true single plate bipolar flow field plate design in which both sides of a single plate can be used as active surfaces. That is, a bipolar flow field plate, according to aspects of embodiments of the present invention, does not require a corresponding rear “passive” surface to provide the advantages of back-side feed described above, since process gases/fluids are communicated from one active surface to the other active surface without having to interact with or even require the existence of a rear-facing passive surface. Accordingly, those skilled in the art would appreciate that, in operation within an assembled electrochemical cell (e.g. electrochemical cell 100), a particular process gas/fluid supplied to or evacuated from the first active surface 121 traverses a portion of the second active surface 122 that is sealingly separated from the primary channels 155 on the second active service 122. Similarly, in operation within an assembled electrochemical cell (e.g. electrochemical cell 100), a particular process gas/fluid supplied to or evacuated from the second active surface 122 traverses a portion of the first active surface 121 that is sealingly separated from the primary channels 150 on the first active service 121.

With reference to FIGS. 3B and 4B shown are two active sides of a second bipolar flow field plate 120′ that is suited for use in the electrochemical cell stack 100′ shown in FIG. 1B. The bipolar flow field plate 120′ has two active surfaces so that it may be employed as both an anode and a cathode simultaneously in two adjacent electrochemical cells in a stack. Specifically, illustrated in FIG. 3B is a first active surface 121′ of the second bipolar flow field plate 120′; and illustrated in FIG. 4B is a second active surface 122′ of the second bipolar flow field plate 120′. The arrangement of features on the second active surface 122′ are substantially identical the arrangement of features on the first active surface 121′ after a 180 degree rotation. Such a configuration permits simplification of the manufacturing process, since only one manufacturing mask is required to produce both active surface 121′ and 122′ of the second bipolar flow field plate 120′. In comparison, the first bipolar flow field plate 120, illustrated in FIGS. 3A and 4A, would require two manufacturing masks since the two active surfaces 121 and 122 are substantially different from one another.

Referring to FIG. 3B, the second bipolar flow field plate 120′, on its first active surface 121′ includes a flow field structure in an active area that is made up of a number of primary channels 150′ defined by a number of ribs 160′. In some embodiments the flow field structure is arranged in a pattern that increases exposure between process gases/fluids in the primary channels 150′ and the MEA 124′ of FIG. 2B.

Referring to FIG. 4B, the second bipolar flow field plate 120′, on its second active surface 122′ includes a flow field structure in an active area that is made up of a number of primary channels 155′ defined by a number of ribs 165′. In some embodiments the flow field structure is arranged in a pattern that increases exposure between process gases/fluids in the primary channels 165′ and the MEA 124′ of FIG. 2B.

With reference to both FIGS. 3B and 4B, the second bipolar flow field plate 120′ includes a number of manifolds or openings for process gas/fluid flow. The second bipolar flow field plate 120′ has an anode inlet manifold 260, an anode outlet manifold 262, a cathode inlet manifold 264 and a cathode outlet manifold 266. With further reference to FIGS. 1B and 2B, the manifolds 260, 262, 264 and 266 are all in fluid communication with respective process gas/fluid connection ports 106′, 107′, 111′, 110′ when the electrochemical cell stack 100′ is assembled.

The anode inlet manifold 260 is in fluid communication with open-faced channels 271 arranged on the first active surface 121′. The open-faced channels 271 are in fluid communication with complementary active-surface feed flow apertures 272, which fluidly connect the open-faced feed channels 271 with the primary channels 155′ on the second active surface 122′. The anode outlet manifold 262 is similarly in fluid communication with open-faced feed channels 273 arranged on the first active side 121′. The open-faced feed channels 273 are in fluid communication with complementary active-surface feed flow apertures 274, which fluidly connect open-faced feed channels 273 with the primary channels 155′ on the second active surface 122′.

The cathode inlet manifold 264 is in fluid communication with open-faced feed channels 276 arranged on the second active surface 122′. The open-faced feed channels 276 are in fluid communication with complementary active-surface feed flow apertures 275, which fluidly connect the open-faced feed channels 276 with the primary channels 150′ on the first active surface 121′. Similarly, the cathode outlet manifold 266 is in fluid communication with open-faced feed channels 278 arranged on the second active side 122′. The open-faced feed channels 278 are in fluid communication with complementary active-surface feed flow apertures 277, which fluidly connect the open-faced feed channels 278 with the primary channels 150′ on the first active surface 121′.

The complementary active-surface feed flow arrangement for the second bipolar flow field plate 120′, shown in FIGS. 3B and 4B is thus similar to what has been described in connection with the first bipolar flow field plate 120 shown in FIGS. 3A and 4A. Accordingly, in-flows and out-flows of process gases/fluids to and from the first and second active surfaces 121′ and 122′ are substantially similar to in-flows and out-flows of process gases/fluids to and from the first and second active surfaces 121 and 122, respectively, as described above. Accordingly, those skilled in the art would appreciate that, in operation within an assembled electrochemical cell (e.g. electrochemical cell 100′), a particular process gas/fluid supplied to or evacuated from the first active surface 121′ traverses a portion of the second active surface 122′ that is sealingly separated from the primary channels 155′ on the second active service 122′. Similarly, in operation within an assembled electrochemical cell (e.g. electrochemical cell 100′), a particular process gas/fluid supplied to or evacuated from the second active surface 122′ traverses a portion of the first active surface 121′ that is sealingly separated from the primary channels 150′ on the first active service 121′.

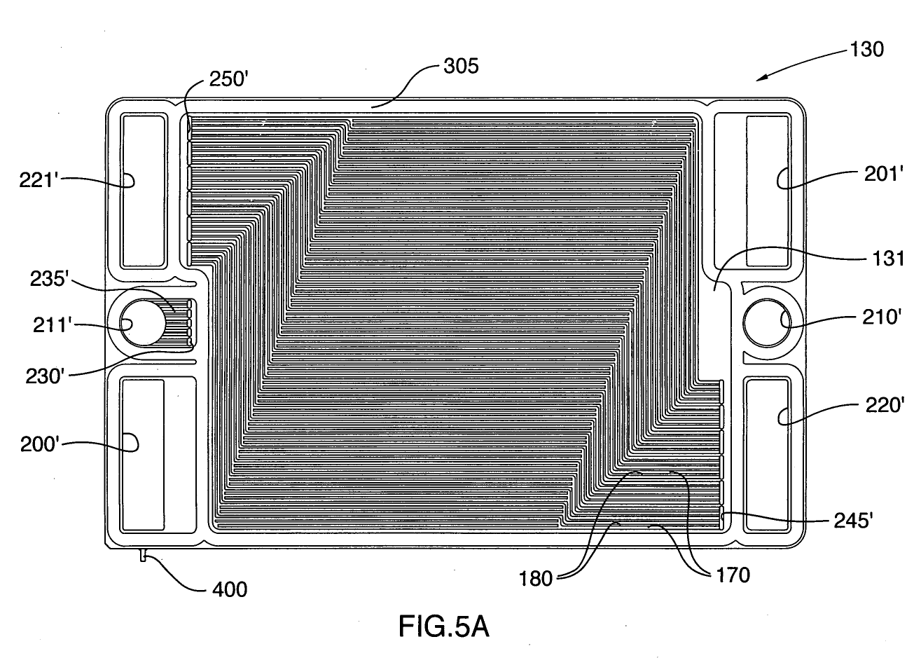

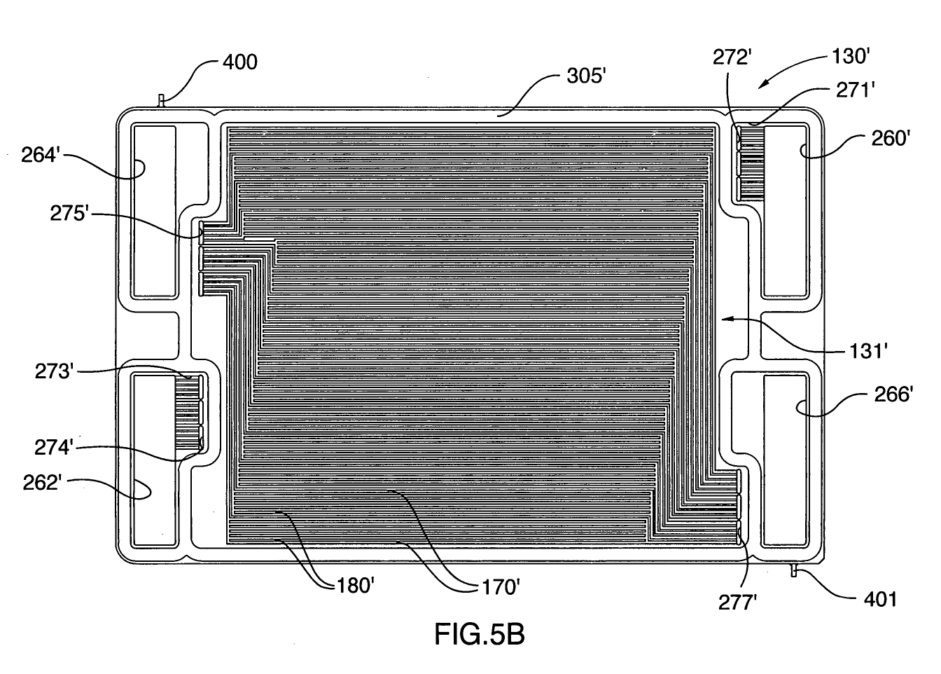

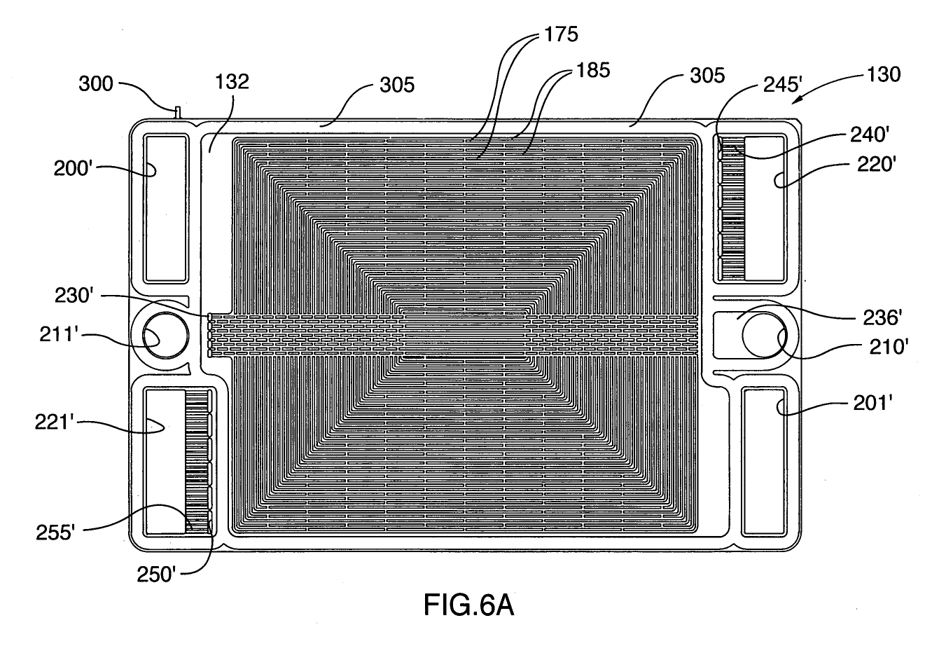

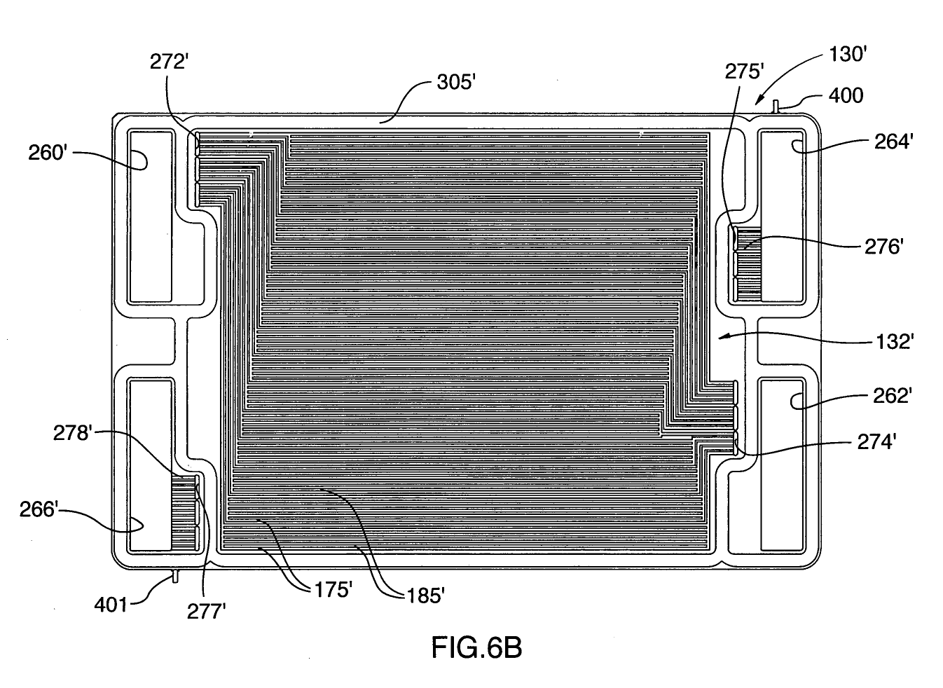

With reference to FIGS. 5A and 6A, shown are two active sides of a third bipolar flow field plate 130 that is suited for use in the electrochemical cell stack 100 shown in FIG. 1A. The bipolar flow field plate 130 has two active surfaces so that it may be employed as both an anode and a cathode simultaneously in two adjacent electrochemical cells in a stack. Specifically, illustrated in FIG. 5A is a first active surface 131 of the third bipolar flow field plate 130; and illustrated in FIG. 6A is a second active surface 132 of the third bipolar flow field plate 130.

The first and second active surfaces 131 and 132 of the third flow field plate 130 are respective mirror images of the first and second active surfaces 121 and 122, shown in FIGS. 3A and 4A, respectively. The first axis of symmetry, used to obtain the arrangement shown in FIG. 5A, is the centred transverse axis 190 illustrated in FIG. 3A. The second axis of symmetry, used to obtain the arrangement shown in FIG. 6A, is the centred transverse axis 195 illustrated in FIG. 4A. By using mirror images of the two surfaces of a flow field plate to produce arrangements from two surfaces of another flow field plate, the manufacturing costs of flow field plates can be kept low, since only one detailed pattern mask (or die or mould, etc.) has to be made (since the “mirror image” pattern mask/die/mould, etc. can be generated from the data used for the first mask). Furthermore, a substantial portion of the ribs of one flow field plate will be positioned in front of the corresponding ribs of another flow field plate when the two plates are assembled, in combination with a suitable membrane, to form an electrochemical cell.

Referring to FIG. 5A, the third bipolar flow field plate 130, on its first active surface 131 includes a flow field structure in an active area that is made up of a number of primary channels 170 defined by a number of ribs 180. In some embodiments the flow field structure is arranged in a pattern that increases exposure between the process gases/fluids in the primary channels 170 and the MEA 124 of FIG. 2A.

Referring to FIG. 6A, the third bipolar flow field plate 130, on its second active surface 132 includes a flow field structure in an active area that is made up of a number of primary channels 175 defined by a number of ribs 185. In some embodiments the flow field structure is arranged in a pattern that increases exposure between the process gases/fluids in the primary channels 175 and the MEA 124 of FIG. 2A.

With reference to both FIGS. 5A and 6A, the third bipolar flow field plate 130 includes a number of manifolds or openings for process gas/fluid flow. A water in-flow manifold 221′ is provided for supplying water to the first active surface 131. A water/oxygen exit manifold 220′ is provided for evacuating water/oxygen from the first active surface 131. A hydrogen out-flow manifold 211′ is provided for evacuating hydrogen from the second active area 132. A hydrogen through manifold 210′, water/oxygen through manifold 200′ and a water through manifold 201′ are provided for directing corresponding process gases/fluids to/from a second flow field plate of an electrochemical cell. With further reference to FIGS. 1A and 2A, the manifolds 200, 201, 210, 211, 220 and 221 are all in fluid communication with corresponding process gas/fluid connection ports 106, 107, 108, 109, 110, 111 when the electrochemical cell stack 100 is assembled.

Further, on the first active surface 131, the third flow field plate 130 has hydrogen complementary active-surface feed flow apertures 230′ in fluid communication with open-faced hydrogen exit channels 235′. The channels 235′ connect the complementary active-surface feed flow apertures 230′ to the hydrogen out-flow manifold 211′. The hydrogen complementary active-surface feed flow apertures 230′ thus fluidly connect the second active surface 132 of the third bipolar flow field plate 130 to the hydrogen out-flow manifold 211′.

Similarly, on the second active surface 132, the third bipolar flow field plate 130 has open-faced water in-flow channels 255′ that are in fluid communication with the water in-flow manifold 221′. The channels 255′ are fluidly connected to water complementary active-surface feed flow apertures 250′ that extend from the second active surface 132 to the first active surface 131, where they are in fluid communication with the primary channels 170. The complementary active-surface feed flow apertures 250′ thus fluidly connect the primary channels 170 within the active area on the first active surface 131 to the water in-flow manifold 221′. Also on the second active surface 132 there are open-faced water out-flow channels 240′ in fluid communication with water out-flow manifold 220′. The channels 240′ are fluidly connected to water complementary active-surface feed flow apertures 245′ that extend from the second active surface 132 to the first active surface 131, where they are in fluid communication with the primary channels 170. The complementary active-surface feed flow apertures 245′ thus fluidly connect the primary channels 170 within the active area on the first active surface 131 to the water out-flow manifold 220′.

The complementary active-surface feed flow arrangement for the third bipolar flow field plate 130′, shown in FIGS. 5A and 6A is similar to what has been described with reference to the first bipolar flow field plate 120 shown in FIGS. 3A and 4A. Accordingly, in-flows and out-flows of process gases/fluids to and from the first and second active surfaces 131 and 132 are substantially similar to in-flows and out-flows of process gases/fluids to and from the first and second active surface 121 and 122, respectively, as described above with respect to the complementary active-surface feed flow channels. Accordingly, those skilled in the art would appreciate that, in operation within an assembled electrochemical cell (e.g. electrochemical cell 100), a particular process gas/fluid supplied to or evacuated from the first active surface 131 traverses a portion of the second active surface 132 that is sealingly separated from the primary channels 175 on the second active service 132. Similarly, in operation within an assembled electrochemical cell (e.g. electrochemical cell 100), a particular process gas/fluid supplied to or evacuated from the second active surface 132 traverses a portion of the first active surface 131 that is sealingly separated from the primary channels 170 on the first active service 131.

With reference to FIGS. 5B and 6B shown are two active sides of a fourth bipolar flow field plate 130′ that is suited for use in the electrochemical cell stack 100′ shown in FIG. 1B. The fourth bipolar flow field plate 130′ has two active surfaces so that it may be employed as both an anode and a cathode simultaneously in two adjacent electrochemical cells in a stack. Specifically, illustrated in FIG. 5B is a first active surface 131′ of the fourth bipolar flow field plate 130′; and illustrated in FIG. 6B is a second active surface 132′ of the fourth bipolar flow field plate 130′. The arrangement of features on the second active surface 132′ are substantially identical the arrangement of features on the first active surface 131′ after a 180 degree rotation. Such a configuration permits simplification of the manufacturing process, since only one manufacturing mask is required to produce both active surfaces 131′ and 132′. Similarly, to manufacturing of the two active surfaces 121′ and 122′ shown in FIGS. 3B and 4B, respectively, would only require the use of one manufacturing mask, since the two active surfaces 121′ and 122′ are substantially identical. In comparison, the third bipolar flow field plate 130, shown in FIGS. 5A and 6A, would require two manufacturing masks since the two active surfaces 131 and 132 are substantially different from one another.

Referring to FIG. 5B, the fourth bipolar flow field plate 130′, on its first active surface 131′ includes a flow field structure in an active area that is made up of a number of primary channels 170′ defined by a number of ribs 180′. In some embodiments the flow field structure is arranged in a pattern that increases exposure between process gases/fluids in the primary channels 170′ and the MEA 124′ of FIG. 2B.

Referring to FIG. 6B, the fourth bipolar flow field plate 130′, on its second active surface 132′ includes a flow field structure in an active area that is made up of a number of primary channels 175′ defined by a number of ribs 185′. In some embodiments the flow field structure is arranged in a pattern that increases exposure between process gases/fluids in the primary channels 175′ and the MEA 124′ of FIG. 2B.

With reference to both FIGS. 5B and 6B, the fourth bipolar flow field plate 130′ includes a number of manifolds or openings for process gas/fluid flow. The fourth bipolar flow field plate 130′ has an anode inlet manifold 260′, an anode outlet manifold 262′, a cathode inlet manifold 264′ and a cathode outlet manifold 266′. With further reference to FIGS. 1B and 2B, the manifolds 260′, 262′, 264′ and 266′ are all in fluid communication with respective process gas/fluid connection ports 106′, 107′, 111′, 110′ when the electrochemical cell stack 100′ is assembled.

The anode inlet manifold 260′ is in fluid communication with open-faced channels 271′ arranged on the first active surface 121′. The open-faced channels 271′ are in fluid communication with complementary active-surface feed flow apertures 272′, which fluidly connect the open-faced feed channels 271′ with the primary channels 175′ on the second active surface 132′. The anode outlet manifold 262′ is similarly in fluid communication with open-faced feed channels 273′ arranged on the first active side 121′. The open-faced feed channels 273′ are in fluid communication with complementary active-surface feed flow apertures 274′, which fluidly connect open-faced feed channels 273 with the primary channels 175′ of the second active surface 132′.

The cathode inlet manifold 264′ is in fluid communication with open-faced feed channels 276′ arranged on the second active surface 132′. The open-faced feed channels 276′ are in fluid communication with complementary active-surface feed flow apertures 275′, which fluidly connect the open-faced feed channels 276′ with the primary channels 170′ on the first active surface 131′. Similarly, the cathode outlet manifold 266′ is in fluid communication with open-faced feed channels 278′ arranged on the second active side 132′. The open-faced feed channels 278′ are in fluid communication with complementary active-surface feed flow apertures 277′, which fluidly connect the open-faced feed channels 278′ with the primary channels 170′ on the first active surface 131′.

The complementary active-surface feed flow arrangement for the fourth bipolar flow field plate 130′, shown in FIGS. 5B and 6B is thus similar to what has been described in connection with the first bipolar flow field plate 120 shown in FIGS. 3A and 4A. Accordingly, in-flows and out-flows of process gases/fluids to and from the first and second active surfaces 131′ and 132′ are substantially similar to in-flows and out-flows of process gases/fluids to and from the first and second active surface 121 and 122, respectively, as described above with respect to the complementary active-surface feed flow channels. Accordingly, those skilled in the art would appreciate that, in operation within an assembled electrochemical cell (e.g. electrochemical cell 100′), a particular process gas/fluid supplied to or evacuated from the first active surface 131′ traverses a portion of the second active surface 132′ that is sealingly separated from the primary channels 175′ on the second active service 132′. Similarly, in operation within an assembled electrochemical cell (e.g. electrochemical cell 100′), a particular process gas/fluid supplied to or evacuated from the second active surface 132′ traverses a portion of the first active surface 131′ that is sealingly separated from the primary channels 170′ on the first active service 131′.

It was noted above that in some embodiments the first, second, third, seventh and ninth areas are arranged on the first active surface so that they correspond to a 180 degree rotated image arrangement of the fourth, tenth, eighth, sixth and fifth areas, respectively, such that features present in the first, second, third, seventh and ninth areas also correspond to images of features in the fourth, tenth, eighth, sixth and fifth areas, respectively, that have been rotated 180 degrees. A comparison of the arrangement of features on each of the active surfaces 121′, 122′, 131′ and 132′ shown in FIGS. 3B, 4B, 5B and 6B, respectively, with one another shows an example of this.

Specifically, a comparison of the arrangement of features on each of the active surfaces 121′, 122′, 131′ and 132′ shown in FIGS. 3B, 4B, 5B and 6B, respectively, with one another reveals each is substantially identical to the other. For each bipolar flow field plate 120′,130′, the first active surface 121′,131′ is rotated 180 degrees (a half rotation) in the plane of a face, with respect to the second active surface 122′,132′. Moreover, in effect the two bipolar flow field plates 120′ and 131′ are substantially identical to one another. The difference in operation being that, if the first active surface 121′, 131′ of each flow field plate 120′,130′ is used as a cathode, then the orientation of adjacent flow field plates has to be arranged so that the corresponding second active surfaces are used as an anode that faces the cathode. In some embodiments, the bipolar flow field plates according to aspects of the invention described herein are made-up of a single plate that is either machined and/or chemically processed to impart the features of the two active surfaces on respective sides of the single plate. Alternatively, in other embodiments a bipolar flow field plate is made up of two plates that are individually mechanically or chemically processed to impart the respective features of one of two active surfaces on front surfaces of each plate and the plates are then bonded together to form the bipolar flow field plate in accordance with aspects of an embodiment of the invention. The rear surfaces are not employed in aspects relating to complementary active-surface feed flow channels in such embodiments of the invention.

In some of an electrochemical cell stack that employ flow field plates like those shown in FIGS. 3B, 4B, 5B and 6B a co-operative relationship among two plates that make up a particular electrochemical cell in the stack is established during the assembly process. More specifically, for example, consider an electrochemical cell stack made up of a number of adjacent electrochemical cells. Each electrochemical cell shares a bipolar flow field plate with another cell adjacent to it such that only the cells on the ends of the stack only share with one other adjacent cell each and the cells not on the ends of the stack share two bipolar flow field plates with two other adjacent cells, respectively. Each bipolar flow field plate has a first and a second active surface. The first active surface is used as the anode in one cell and the second active surface is used as the cathode in an adjacent cell. The first active surface has a number of features as does the second active surface, as described with respect to the figures.

Accordingly, within any electrochemical cell in the stack the first active surface of a first bipolar flow field plate faces the second active surface of a second bipolar flow field plate. If the plates are like those shown in FIGS. 3B, 4B, 5B and 6B the first and second bipolar flow field plates are arranged such that the second active surface of the second bipolar flow field plate is rotated 180 degrees (or a half-rotation) with respect to the orientation of the first active area on the first bipolar flow field plate, if the starting position of both plates is such that the noted first and second active surfaces on the first and second bipolar plates, respectively, are identical to one another. In other words, the first bipolar flow field plate of each cell is arranged in a first direction and the second bipolar flow field plate of each cell is arranged in a direction where, starting from a situation where the first and second bipolar flow field plates face the same direction and are oriented the same way, the second flow field plate is rotated 180 degrees about a longitudinal axis of the second flow field plate and then rotated 180 degrees about an axis perpendicular to the general plane of the second flow field plate

In some embodiments, a number of tabs can be included on the edges of a flow field plate. The tabs provide a contacting means and an orientation means for the flow field plates that include them. That is, a tab can be used as an electrical contact point to a particular flow field plate to measure, for example, the electric potential of the flow field plate relative to some other point (e.g. ground, another flow field plate, etc.). Additionally, one or more tabs can be used to aid a person assembling an electrochemical cell arrange constituent flow field plates so that the features of the flow field plates are correctly aligned with one another. In other embodiments, flow field plates are provided with numerous tabs and some of the tabs can be intentionally broken off to aid in identifying a particular flow field plate configuration as either a first flow field plate or a second flow field plate in a alternating sequence of first and second flow field plates that make-up an electrochemical cell. Those skilled in the art would appreciate that numerous combinations of tab placement, shapes and quantities are possible and within the scope of numerous embodiments of the invention.

Again, some embodiments flow field plates include a single tab. For example, with reference to FIGS. 3A, 4A, 5A and 6A, the bipolar flow field plates 120,130 shown, include a single tab 400. During assembly of an electrochemical cell stack using one of the bipolar flow field plates 120,130 for all of the constituent flow field plates that will make up the electrochemical cell stack, the tabs 400 on each of the constituent flow field plates should all be present on the same side of an electrochemical cell stack and adjacent each other, because all of the constituent flow field plates will be identical and the placement of the respective tab 400 on each will be the same.

In other embodiments the flow field plates are provided with multiple tabs. In such embodiments the placement of each tab on a particular tab is different from the placement of all other tabs on the particular flow field plate. Moreover, in some such embodiments the shape of each of the tabs included on a flow field plate is different from the shape of all other tabs included on the flow field plate, so that the tabs can be easily distinguished from one another by their shape and placement on the flow field plate. For example, with reference to FIGS. 3B, 4B, 5B and 6B, the bipolar flow field plates 120′,130′ each include a first tab 400 and a second tab 401. On both bipolar flow field plates 120′,130′ the second tab 401 is located diagonally opposite the location of the first tab 400. In other embodiments, the tabs 400,401 may be arranged on the same side of the bipolar flow field plates 120′, 130′ (not shown). Again, during assembly of an electrochemical stack the tabs 400, 401 are used to properly arrange the constituent flow field plates that make up the electrochemical cell stack. Moreover, during operation and testing of the stack the tabs 400,401 can be used as electrical contact points to a particular constituent flow field plate.

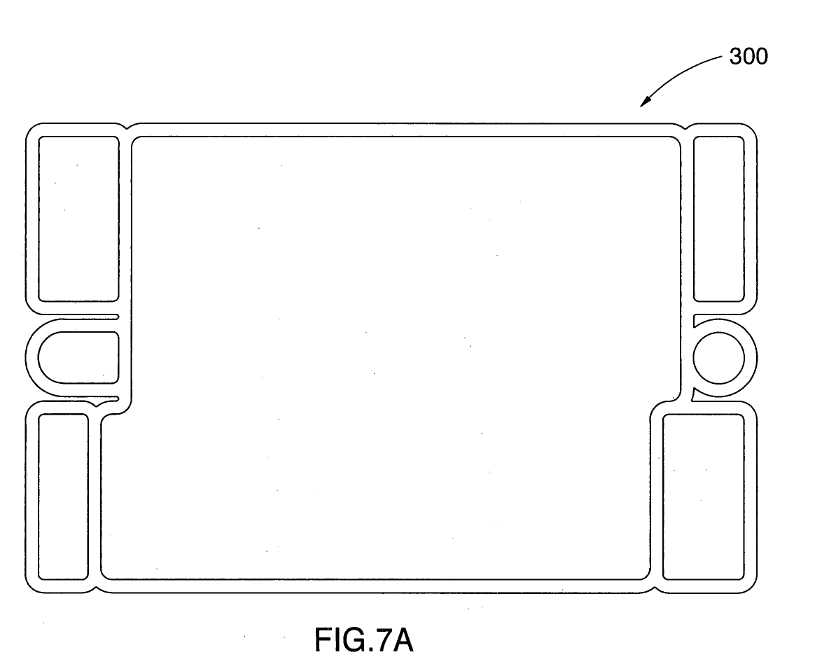

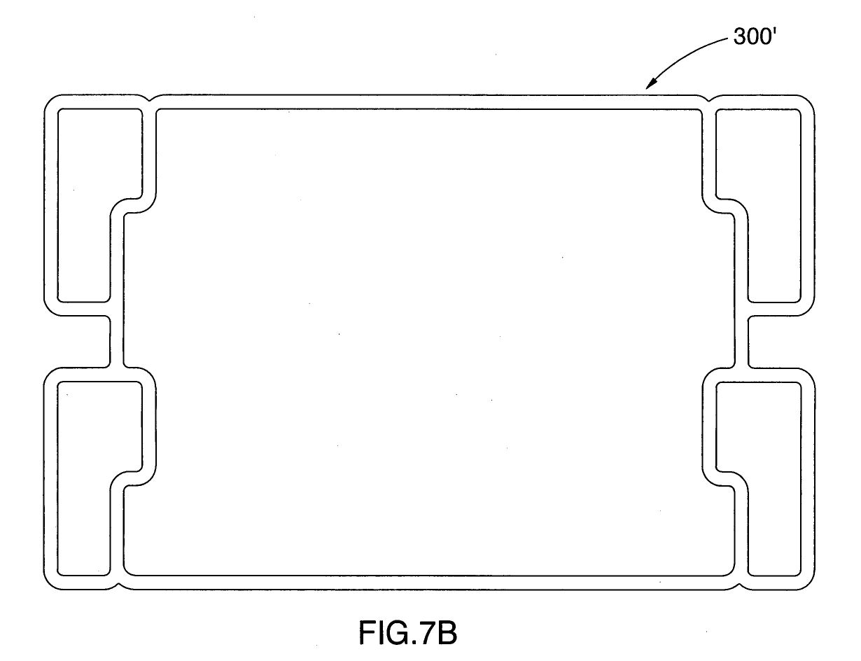

In some embodiments active surfaces of a flow field plate include gasket grooves into which gaskets are sealingly inserted during assembly of an electrochemical cell stack. The gasket grooves distinctly separate manifolds, used to supply and evacuate process gases/fluids to and from an active area. That is, the gaskets inserted in the gasket grooves provide the sealing for a membrane from manifolds, as described above. With reference to FIGS. 3A to 6B the bipolar flow field plates shown are appropriately provided with gasket grooves 305 and 305′ (on both active surfaces as required). Referring now to FIG. 7A, shown is a gasket 300 that is suited for use with the bipolar flow field plates 120,130 shown in FIGS. 3A, 4A, 5A and 6A. Similarly, shown in FIG. 7B is a gasket 300′ that is suited for use with the bipolar flow field plates 120′,130′ shown in FIGS. 3B, 4B, 5B and 6B.

The gaskets 300, 300′, as shown separately in FIGS. 7A and 7B provide the necessary sealing between different flow field plates and the membrane, or between a first and last flow field plate and the corresponding bus bar, in an assembled electrochemical cell stack. For example, with reference to FIGS. 3A and 4A, open-faced hydrogen exit channels 235 are sealed by gasket 300 and thus define a sealed space together with a similarly sealed flat surface 236 arranged on another bipolar flow field plate that would be used to make up a particular electrochemical cell. Similarly, with reference to FIGS. 5A and 6A, open-faced hydrogen exit channels 235′ are sealed by gasket 300 and thus define a sealed space together with a similarly sealed flat surface 236′ arranged on another bipolar flow field plate that would be used to make up a particular electrochemical cell. Similarly, with reference to FIGS. 3B and 7B, the gasket 300′ (in FIG. 7B) effectively seals the primary channels 150′, when the plates are assembled together in a stack, to prevent cross-over of process gas from one manifold (e.g. manifold 260) area to another (e.g. manifold 266), and also around the complementary active-surface feed flow aperture areas (e.g. complementary active-surface feed flow apertures 272).

As noted above, in some embodiments all of the flow field plates that make up an electrochemical cell stack are substantially identical. That is, the arrangement of features on one of the two active surfaces is identical to the arrangement of features on the other of the two active surfaces; and since the two active surfaces are identical, only one manufacturing mask or mold or stamp is required for the manufacture of the plates.

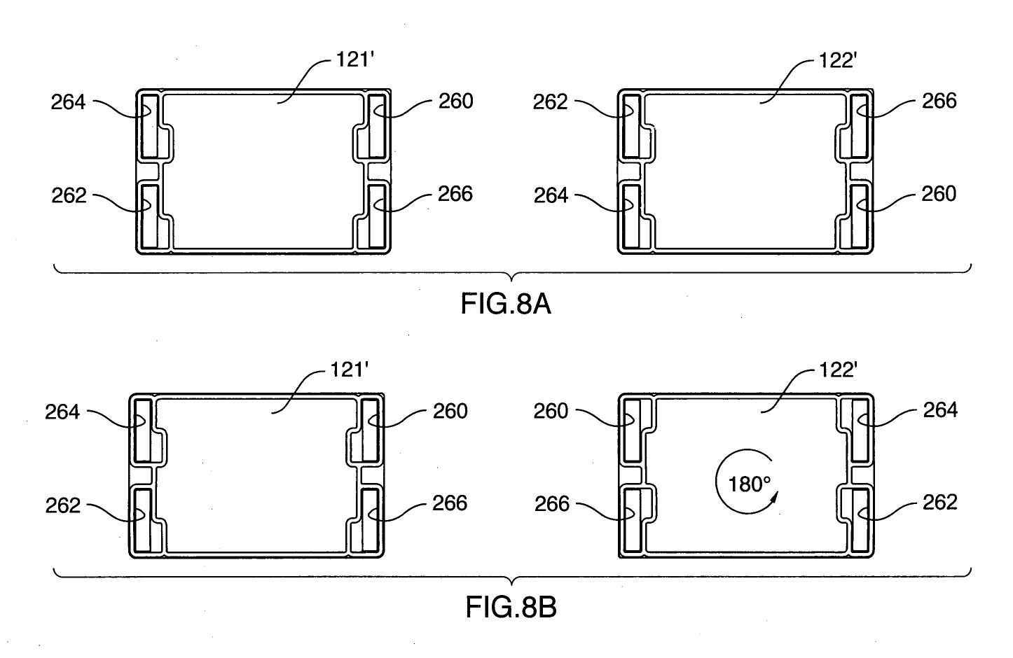

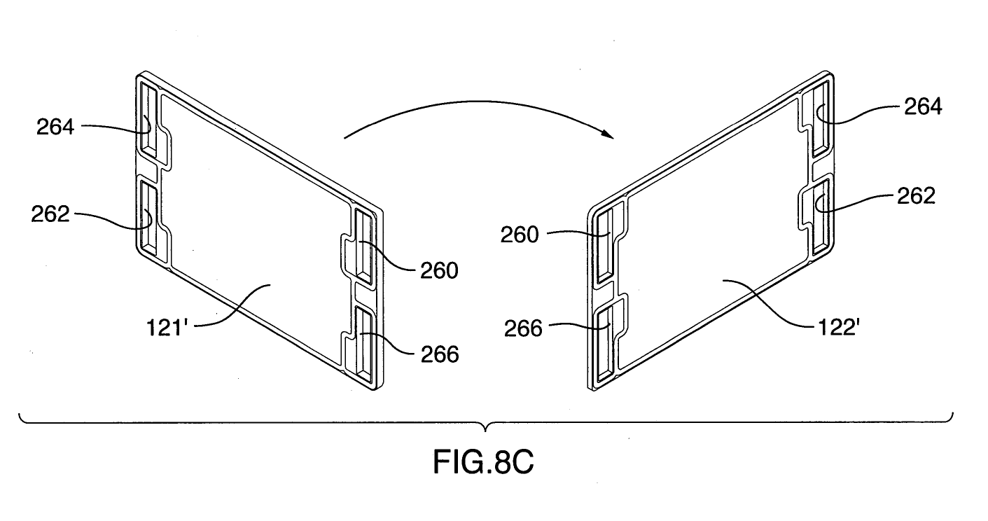

For example, with reference to FIGS. 3B and 4B, to manufacture the bipolar flow field plate 120′ from a first flow field plate and a second flow field plate, the first and second flow field plates are processed by chemical etching using a manufacturing photo-mask to impart the features of the first and second active surfaces 121′, 122′ on the first and second flow field plates, respectively. The first and second flow field plates are bonded together back to back, such that the two active surfaces 121′,122′ face away from one another, to produce the bipolar flow field plate 120′. The process of connecting the first and second plates, identified by active surfaces 121′ and 122′, is illustrated by way of example in FIGS. 8A, 8B and 8C. In FIGS. 8A to 8C, first and second active surfaces 121′,122′ are shown in a simplified form for the purposes of illustrating a portion of the manufacturing process.

Referring to FIG. 8A, starting from a first position where the first and second active surfaces 121′,122′ face the same direction and are oriented the same way, the second flow field plate is rotated 180 degrees one rotated 180 degrees whilst still facing the same direction to arrive at a second position shown in FIG. 8B. The second flow field plate is then flipped over (mirrored vis-à-vis the first flow field plate) as illustrated in FIG. 8C, so that the two active surfaces 121′,122′ face away from one another. The two flow field plates are then bonded together back-to-back to produce the bipolar flow field plate 120′, shown in FIGS. 3B and 4B. The first and second flow field plates are bonded together using an appropriate bonding process, such as brazing, laser welding, conductive adhesive application or other bonding processes providing a bond that is compatible with the corrosive environment of the electrochemical cell in question.

According to other embodiments a bipolar flow field plate can be produced using a single plate having two oppositely facing surfaces. Features of a flow field arrangement for a first active surface can be imparted onto one of the two oppositely facing surfaces and features of a flow field arrangement for a second active surface can be imparted onto the other of the two oppositely facing surfaces. Producing a bipolar flow field plate in this way reduces the amount of material required, thus reducing the weight of a bipolar flow field plate and an electrochemical cell stack made-up of a number of such plates.

Moreover, in some embodiments a Gas Diffusion Media (GDM) (not shown) suitable for use in an electrochemical cell stack is also symmetrical, and accordingly, only one type of GDM is necessary for assembling an electrochemical cell stack. In other embodiments a GDM produced must be rotated or flipped over (“mirrored”), during the assembly process, relative to a corresponding active surface to fit the appropriate flow field plate pattern on the active area of a active surface and only the orientation of the GDM vis-à-vis the flow field pattern is of relative importance. Nevertheless, the pattern on the GDM is not significantly different from the pattern on the active area of a corresponding active surface of a flow field plate. This may lead to manufacturing and cost savings.

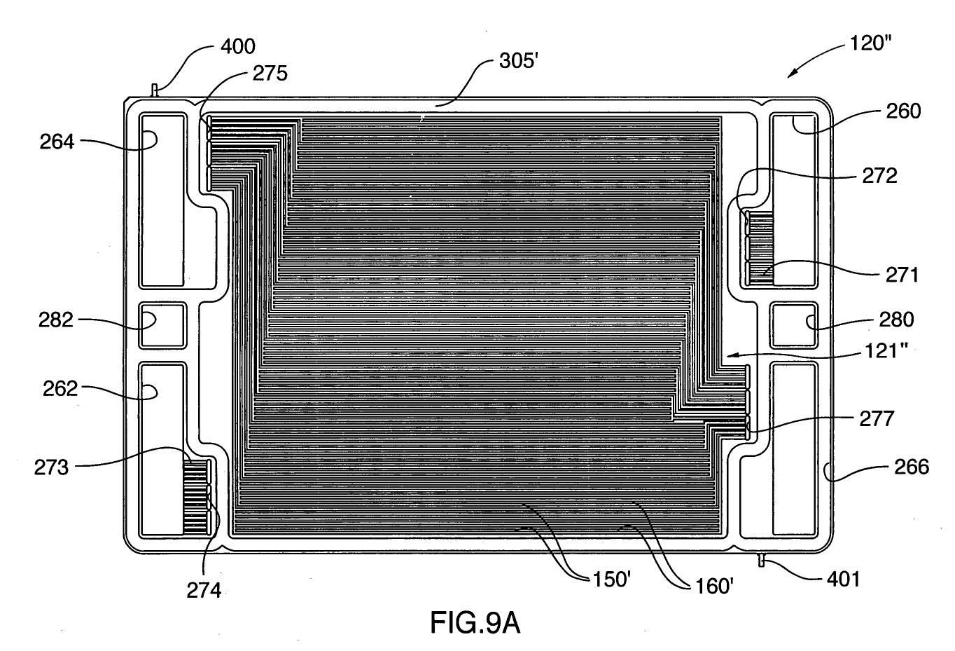

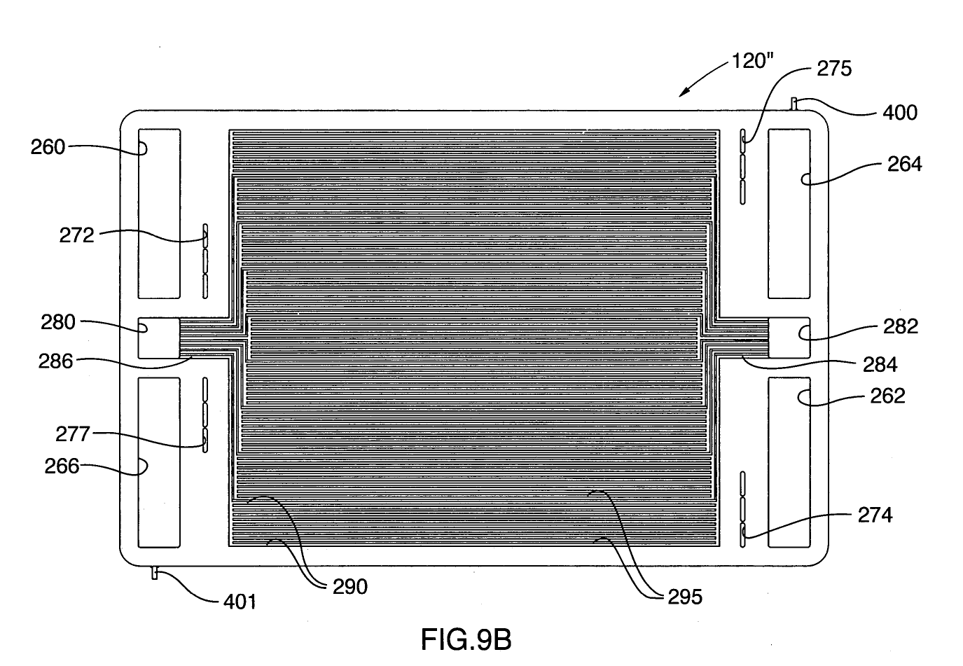

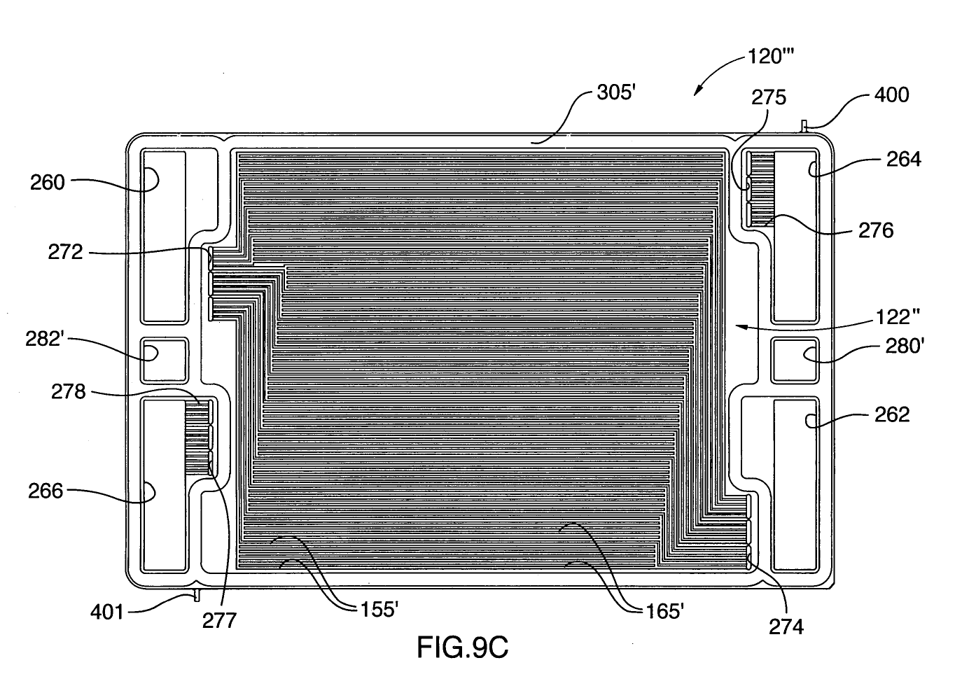

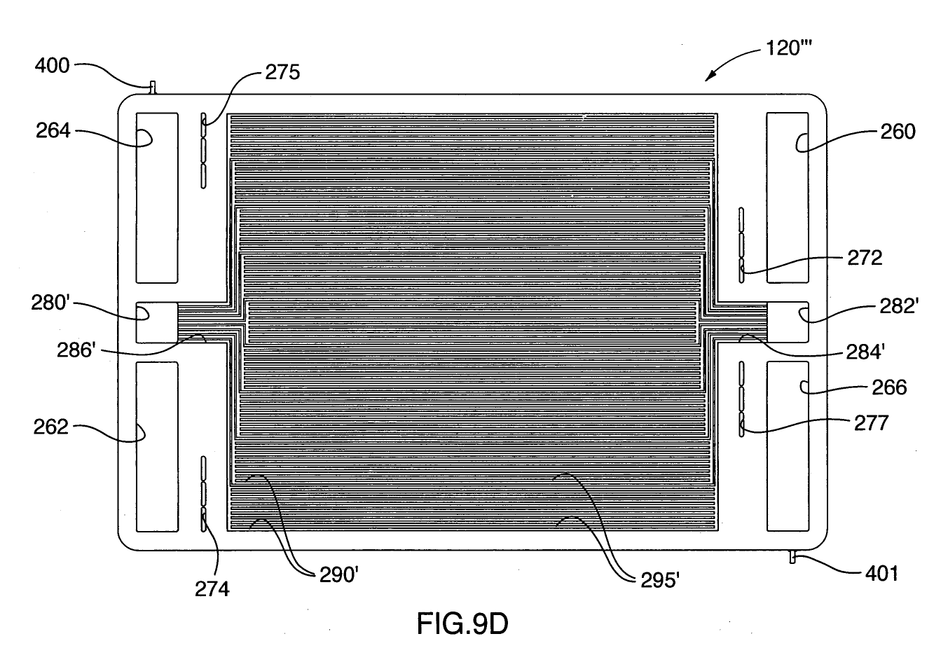

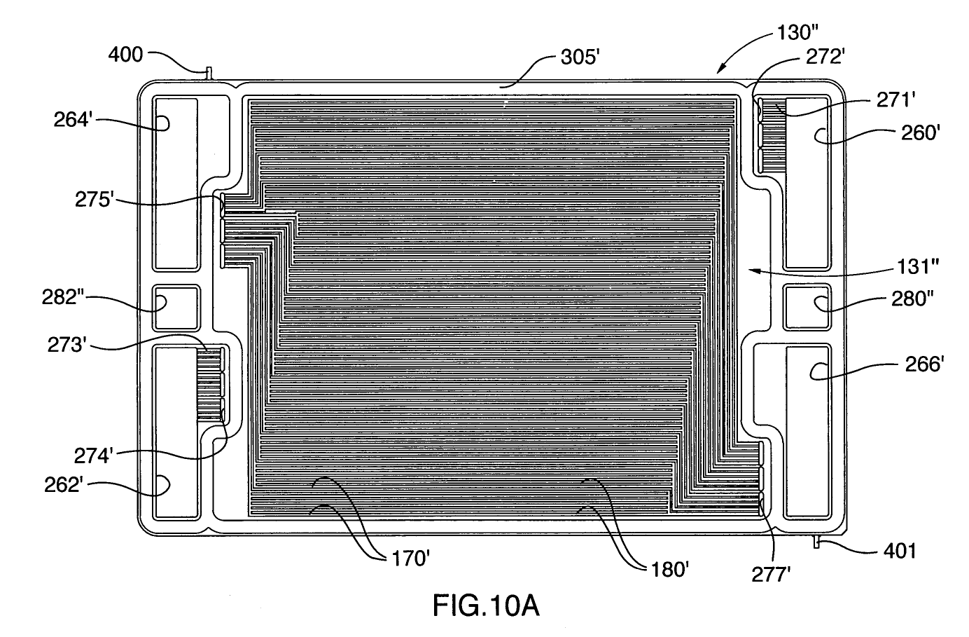

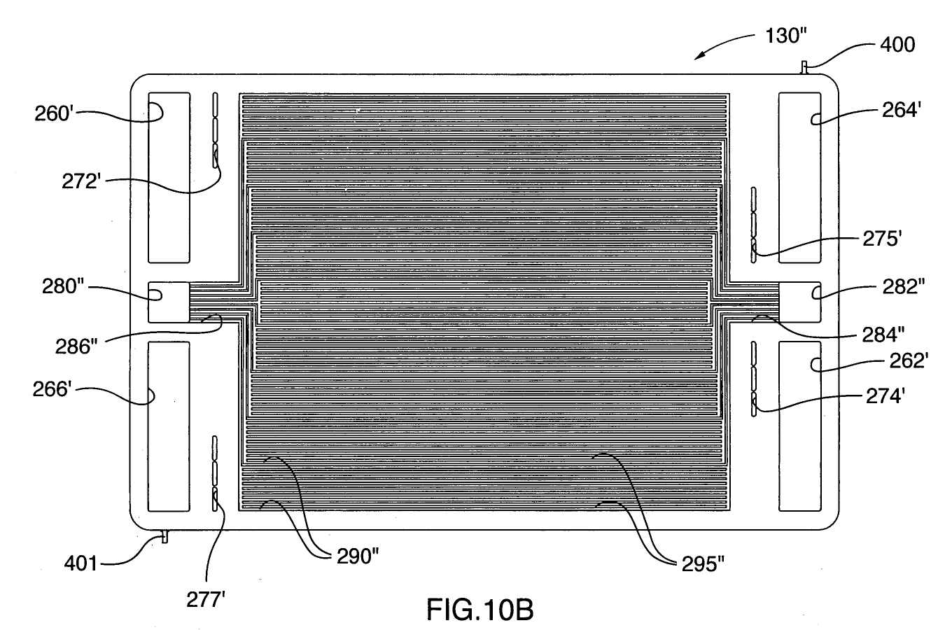

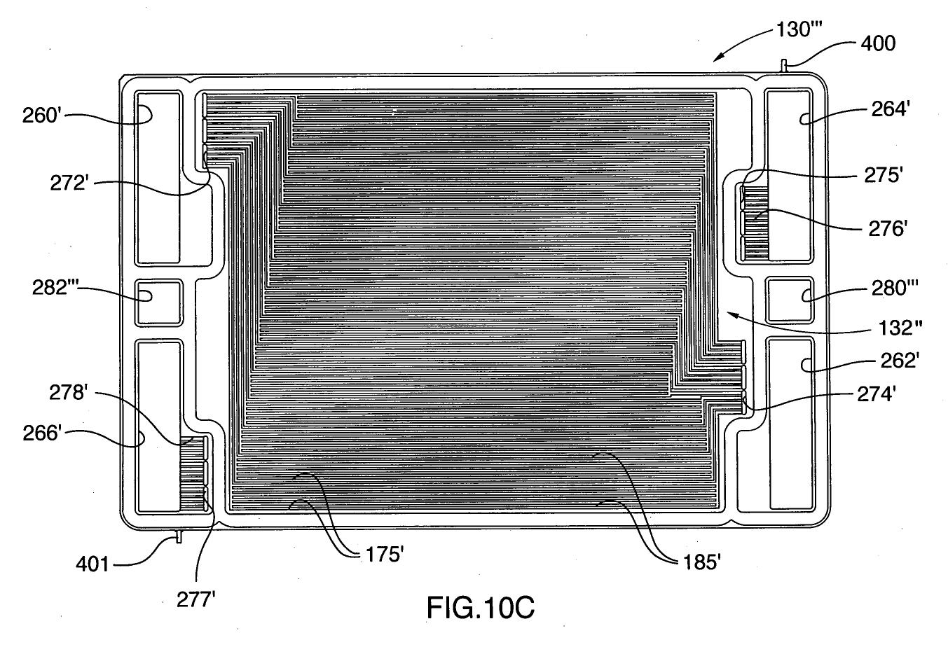

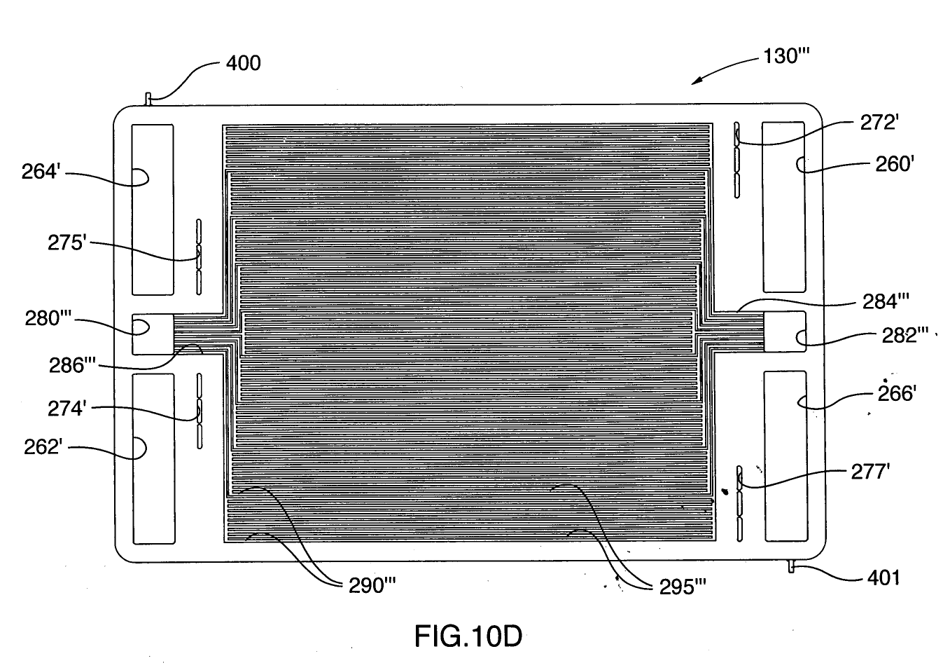

It was noted above that according to aspects of some embodiments of the invention, a flow field plate having a rear surface is provided with coolant channels on the rear surface. It is to be understood that the rear surface is a “passive” or “non-active” surface since it does not directly or indirectly come into contact with a membrane in an assembled electrochemical cell stack. FIGS. 9A to 10D show schematic drawings of examples of flow field plates that include cooling channels on non-active surfaces. Coolant is supplied to and evacuated from the cooling channels by manifolds on the flow field plates.

Referring to FIG. 9A, illustrated is a schematic view of a front (active) surface 121″ of a first flow field plate 120″ suited for use in the electrochemical cell stack 100 shown in FIG. 1A. FIG. 9B shows a schematic view of a rear (passive/cooling) surface of the first flow field plate 120″ shown in FIG. 9A. The front surface 121″ of the first flow field plate 120″ shown in FIG. 9A is almost identical to the first active surface 121′ shown in FIG. 3B with the addition of: a first coolant manifold 280 located between the anode inlet manifold 260 and cathode outlet manifold 266; and, a second coolant manifold 282 located between cathode inlet manifold 264 and anode inlet manifold 262. All other features are identical to those shown in FIG. 3B, and, accordingly, the same reference numbers have been used.

FIG. 9B shows a coolant area of the first flow field plate 120″, arranged on the rear surface of the flow field plate 120″. The first coolant manifold 280 is connected to a coolant flow field pattern made up of channels 290 and ridges 295 via first coolant flow channels 286. The second coolant manifold 282 is connected to the coolant flow field pattern via second coolant flow channels 284.

Similarly, referring to FIG. 9C, illustrated is a schematic view of a front (active) surface 122″ of a second flow field plate 120′″ suited for use in the electrochemical cell stack 100 shown in FIG. 1A. FIG. 9D shows a schematic view of a rear (passive/cooling) surface of the second flow field plate 120′″ shown in FIG. 9C. The front surface 122″ of the second flow field plate 120′″ shown in FIG. 9C is almost identical to the second active surface 122′ shown in FIG. 4B with the addition of: a first coolant manifold 280′ located between the anode inlet manifold 260 and cathode outlet manifold 266; and, a second coolant manifold 282′ located between cathode inlet manifold 264 and anode inlet manifold 262. All other features are identical to those shown in FIG. 4B, and, accordingly, the same reference numbers have been used.

FIG. 9D shows a coolant area of the second flow field plate 120′″, arranged on the surface opposite the active area 122″. The first coolant manifold 280′ is connected to a coolant flow field pattern made up of channels 290′ and ridges 295′ via first coolant flow channels 286′. The second coolant manifold 282′ is connected to the coolant flow field pattern via second coolant flow channels 284′.

The flow field plates 120″ and 120′″ shown in FIGS. 9A-9D can be bonded to one another back-to-back to form a bipolar flow field plate that is similar to the bipolar flow field plate 120′ shown in FIGS. 3B and 4B. The difference is that the bipolar flow field plate formed using the flow field plates 120″ and 120′″ includes a coolant channel between individual flow field plates 120″ and 120′″.

Referring to FIG. 10A shows a schematic view of a front (active) surface 131″ of a third flow field plate 130″ suited for use in the electrochemical cell 100 stack shown in FIG. 1A. FIG. 10B shows a schematic view of a rear (passive/cooling) surface of the third flow field plate 130″ shown in FIG. 10A. The front surface 131′ of the third flow field plate 130″ shown in FIG. 10A is almost identical to the first active surface 131′ shown in FIG. 5B with the addition of: a first coolant manifold 280″ located between the anode inlet manifold 260′ and cathode outlet manifold 266′; and, a second coolant manifold 282″ located between cathode inlet manifold 264′ and anode inlet manifold 262′. All other features are identical to those shown in FIG. 5B, and, accordingly, the same reference numbers have been used.

FIG. 10B shows a coolant area of the third flow field plate 130″, arranged on the rear surface of the flow field plate 130″. The first coolant manifold 280″ is connected to a coolant flow field pattern made up of channels 290″ and ridges 295″ via first coolant flow channels 286″. The second coolant manifold 282″ is connected to the coolant flow field pattern via second coolant flow channels 284″.

Similarly, referring to FIG. 10C, illustrated is a schematic view of a front (active) surface 132″ of a fourth flow field plate 130′″ suited for use in the electrochemical cell stack 100 shown in FIG. 1A. FIG. 10D shows a schematic view of a rear (passive/cooling) surface of the fourth flow field plate 130′″ shown in FIG. 10C. The front surface 132″ of the fourth flow field plate 130′″ shown in FIG. 10C is almost identical to the second active surface 132′ shown in FIG. 6B with the addition of: a first coolant manifold 280′″ located between the anode inlet manifold 260′ and cathode outlet manifold 266′; and, a second coolant manifold 282′″ located between cathode inlet manifold 264′ and anode inlet manifold 262′. All other features are identical to those shown in FIG. 6B, and, accordingly, the same reference numbers have been used.

FIG. 10D shows a coolant area of the fourth flow field plate 130′″, arranged on the surface opposite the active area 132″. The first coolant manifold 280′″ is connected to a coolant flow field pattern made up of channels 290′″ and ridges 295′″ via first coolant flow channels 286′″. The second coolant manifold 282′″ is connected to the coolant flow field pattern via second coolant flow channels 284′″.

The flow field plates 130″ and 130′″ shown in FIGS. 10A-10D can be bonded to one another to form a bipolar flow field plate that is similar to the bipolar flow field plate 130′ shown in FIGS. 5B and 6B. The difference is that the bipolar flow field plate formed using the flow field plates 130″ and 130′″ includes a coolant channel between individual flow field plates 130″ and 130′″.

In some embodiments, bipolar flow field plates, made of two flow field plates (i.e. constituent flow field plates) as described above with reference to FIGS. 9A-10D, do not have cooling channels on both of the two respective flow field plates. Cooling channels can be provided on only one of the two respective flow field plates that make up a bipolar flow field plate. That is, in some embodiments, only alternating flow field plates have coolant channels. Alternatively, an electrochemical cell stack, in some embodiments, is made up of alternating types of electrochemical cells in which only odd numbered cells have coolant channels between the two active surfaces (e.g. using a combination of flow field plates with and without coolant channels) Alternatively, combinations other than alternating (e.g. every third, fourth etc. cell) may be used. This may not be much of a manufacturing advantage for stamped plates, since stamped plates already require the joining of two stamped halves. However, this is an advantage for composite, sintered or chemically etched plates, since the features for both active surfaces could be imported onto a single composite substrate, green pressed sinter body or chemically etched onto a single metal substrate.

What has been described is merely illustrative of the application of aspects of some embodiments of the invention. Other arrangements can be implemented by those skilled in the art, without departing from the scope of the invention.

For example, although the present invention has been described with respect to PEM electrochemical cells, those skilled in the art would appreciate that this invention also applies to other types of electrochemical cells such as alkaline cells.

Also, the “seal-in-place” technique taught in the applicant's co-pending U.S. application Ser. No. 09/854,362 could advantageously be used in combination with aspects of embodiments of the present invention. The entire contents of U.S. application Ser. No. 09/854,362 are hereby incorporated by reference.

1. A flow field plate suited for use in an electrochemical cell comprising:
an active surface having a first area, a second area and a third area;
an active area within the first area;
a first complementary active-surface feed flow aperture located within the first area, extending through the thickness of the flow field plate and fluidly connected to the active area over a portion of the first area;
a first manifold within the second area;
a second manifold within the third area;
a second complementary active-surface feed flow aperture located within the third area, extending through the thickness of the flow field plate and fluidly connected to the second manifold over a portion of the third area, such that in use at least one of a process gas and a process fluid traverses a portion of the active surface without being introduced to the active area; and
a sealing surface separating each of the first, second and third areas from one another.

2. A flow field plate according to claim 1, wherein the sealing surface further comprises a gasket groove.

3. A flow field plate according to claim 1, wherein the active surface further comprises:
a fourth area separated from the first, second and third areas by the sealing surface;
a third manifold within the fourth area; and
a third complementary active-surface feed flow aperture located within the first area, extending through the thickness of the flow field plate and fluidly connected to the active area over a portion of the first area.

4. A flow field plate according to claim 3, wherein the active surface further comprises:
a fifth area separated from the first, second, third and fourth areas by the sealing surface;
a fourth inlet manifold within the fifth area; and
a fourth complementary active-surface feed flow aperture located within the fifth area, extending through the thickness of the flow field plate and fluidly connected to the fourth manifold over a portion of the fifth area, such that in use at least one of a process gas and a process fluid traverses a portion of the active surface without being introduced to the active area.

5. A flow field plate according to claim 1 further comprising:
a rear passive surface oppositely facing the active surface, the rear passive surface having cooling channels; and
an inlet coolant manifold fluidly connected to the cooling channels over a portion of the rear passive surface;
an outlet coolant manifold fluidly connected to the cooling channels over a portion of the rear passive surface; and
the inlet and outlet coolant manifolds separated from each other and the first, second and third areas by the sealing surface on the active surface of the flow field plate.

6. A flow field plate according to claim 1, wherein the active surface further comprises:
a fourth area separated from the first, second and third areas by the sealing surface;
a third manifold within the fourth area; and
a third complementary active-surface feed flow aperture located within the fourth area, extending through the thickness of the flow field plate and fluidly connected to the third manifold over a portion of the fourth area, such that in use at least one of a process gas and a process fluid traverses a portion of the active surface without being introduced to the active area.

7. A flow field plate according to claim 1, wherein the active area contains a flow field structure for uniformly distributing one of the process gas and the process fluid across the active area.

8. A flow field plate according to claim 1, wherein the first, second and third areas are symmetrically arranged on the active surface.

9. A flow field plate according to claim 4, wherein the first, second, third, fourth and fifth areas are symmetrically arranged on the active surface.

10. A flow field plate according to claim 1, wherein the first manifold is designated as one of an anode inlet manifold and a cathode inlet manifold.

11. A flow field plate according to claim 1, wherein the second manifold is designated as one of an anode inlet manifold and a cathode inlet manifold.

12. A flow field plate according to claim 4, wherein the first, second, third and fourth manifolds are designated as an anode inlet manifold, a cathode inlet manifold, an anode outlet manifold and a cathode outlet manifold, respectively.

13. A flow field plate according to claim 12, wherein the anode inlet manifold is larger than the cathode inlet manifold.

14. A flow field plate according to claim 12, wherein the cathode inlet manifold is larger than the anode inlet manifold.

15. A flow field plate according to claim 12, wherein the anode outlet manifold is larger than the cathode outlet manifold.

16. A flow field plate according to claim 12, wherein each manifold has a unique size.

17. A flow field plate according to claim 4, wherein the first, second, third and fourth manifolds are designated as a cathode inlet manifold, an anode inlet manifold, a cathode outlet manifold and an anode outlet manifold, respectively.

18. An electrochemical cell stack comprising:
two adjacent electrochemical cells;
the two electrochemical cells co-operatively sharing a bipolar flow field plate having a first active surface and a second active surface, the first active surface serving as an anode for one of the two adjacent electrochemical cells and the second active surface serving a cathode for the other of the two adjacent electrochemical cells, and each active surface having a respective active area;
the bipolar flow field plate having a first manifold; and
the bipolar flow field plate having a first complementary active-surface feed flow aperture extending through the thickness of the bipolar flow field plate, fluidly connected to the first manifold over a portion of the second active surface and fluidly connected to the active area of the first active surface over a portion of the first active surface, such that in use at least one of a process gas and a process fluid, traveling to or from the active area of the first active surface, traverses a portion of the second active surface without being introduced to the active area of the second active surface.

19. An electrochemical cell stack according to claim 18, wherein the bipolar flow field plate further comprises:
a second manifold; and
a second complementary active-surface feed flow aperture extending through the thickness of the bipolar flow field plate, fluidly connected to the second manifold over a portion of the first active surface and fluidly connected to the active area of the first active surface over a portion of the first active surface, such that in use at least one of a process gas and a process fluid, traveling to or from the active area of the second active surface, traverses a portion of the first active surface without being introduced to the active area of the first active surface.

20. An electrochemical cell stack according to claim 18, wherein the bipolar flow field plate is comprised of two separate plates that have been brought together so as to align back-to-back, the two separate plates manufactured such that the first active surface is on one plate and the second active surface is on the other plate.

21. A bipolar flow field plate suited for use in an electrochemical cell comprising:
a first active surface having first, second and third areas that are each separated from one another by a first sealing surface;
a second active surface, oppositely facing the first active surface, having fourth, fifth and six areas that are each separated from one another by a second sealing surface;
a first active area within the first area;
a second active area within the fourth area;
a first manifold extending through the bipolar flow field plate from the second area to the fifth area;
a second manifold extending through the bipolar flow field plate from the third area to the sixth area;
a first complementary active-surface feed flow aperture extending through the bipolar flow field plate from the first area to the fifth area, fluidly connected to the first manifold over a portion of the fifth area and fluidly connected to the first active area over a portion of the first area; and
a second complementary active-surface feed flow aperture extending through the bipolar flow field plate from the third area to the fourth area, fluidly connected to the second manifold over a portion of the third area and fluidly connected to the second active area over a portion of the fourth area.

22. A bipolar flow field plate according to claim 21, wherein the first, second and third areas are arranged on the first active surface so that they correspond to a mirror image arrangement of the fourth, fifth and sixth areas, respectively, such that features present in the first, second and third areas also correspond to mirror images of features in the fourth, fifth and sixth areas, respectively.

23. A bipolar flow field plate according to claim 21 further comprising:
a seventh area on the first active surface separated from the first, second and third areas by the first sealing surface;
an eighth area on the second active surface separated from the fourth, fifth, and sixth areas by the second sealing surface;
a third manifold extending through the bipolar flow field plate from the seventh area to the eighth area; and
a third complementary active-surface feed flow aperture extending through the bipolar flow field plate from the first area to the eighth area, fluidly connected to the third manifold over a portion of the eighth area and fluidly connected to the first active area over a portion of the first area.

24. A bipolar flow field plate according to claim 23, wherein the first, second, third and seventh areas are arranged on the first active surface so that they correspond to a mirror image arrangement of the fourth, fifth, sixth and eighth areas, respectively, such that features present in the first, second, third and seventh areas also correspond to mirror images of features in the fourth, fifth, sixth and eighth areas, respectively.

25. A bipolar flow field plate according to claim 23 further comprising:
a ninth area on the first active surface separated from the first, second, third and seventh areas by the first sealing surface;
a tenth area on the second active surface separated from the fourth, fifth, sixth, and eighth areas by the second sealing surface;
a fourth manifold extending through the bipolar flow field plate from the ninth area to the tenth area; and
a fourth complementary active-surface feed flow aperture extending through the bipolar flow field plate from the fourth area to the ninth area, fluidly connected to the fourth manifold over a portion of the ninth area and fluidly connected to the second active area over a portion of the fourth area.

26. A bipolar flow field plate according to claim 25, wherein the first, second, third, seventh and ninth areas are arranged on the first active surface so that they correspond to a mirror image arrangement of the fourth, fifth, sixth, eighth and tenth areas, respectively, such that features present in the first, second, third, seventh and ninth areas also correspond to mirror images of features in the fourth, fifth, sixth, eighth and tenth areas respectively.

27. A bipolar flow field plate according to claim 25, wherein the first, second, third, seventh and ninth areas are arranged on the first active surface so that they correspond to a 180 degree rotated image arrangement of the fourth, tenth, eighth, sixth and fifth areas, respectively, such that features present in the first, second, third, seventh and ninth areas also correspond to images of features in the fourth, tenth, eighth, sixth and fifth areas, respectively, that have been rotated 180 degrees.

28. A bipolar flow field plate according to claim 21, wherein the first active surface and the second active surface are on oppositely facing surfaces of a single plate.

29. A bipolar flow field plate according to claim 21, wherein the first active surface is located on a first plate and the second active surface is located on a second plate and the first and second plates are connectable so that the first and second active surfaces face opposite directions.

30. A bipolar flow field plate according to claim 29 further comprising:
an inlet coolant manifold extending through both of the first and second plates;
an outlet coolant manifold extending through both of the first and second plates,
wherein the inlet and outlet coolant manifolds are separated from each other and the first, second and third areas by the first sealing surface on the first active surface located on the first plate, and the inlet and outlet coolant manifolds are separated from each other and the fourth, fifth and sixth areas by the second sealing surface on the second active surface located on the second plate; and
at least one of the first and second plates further comprises a rear passive surface oppositely facing the respective first or second active surface, the rear passive surface having cooling channels that are fluidly connected to the inlet and outlet coolant manifolds over respective portions of the rear passive surface.

31. A bipolar flow field plate according to claim 21, wherein the first active area has a flow field structure for uniformly distributing at least one of a process gas and a process fluid across the first active area.

32. A bipolar flow field plate according to claim 21, wherein the second active area has a flow field structure for uniformly distributing at least one of a process gas and a process fluid across the second active area.

33. A bipolar flow field plate according to claim 31, wherein the second active area has a flow field structure for uniformly distributing at least one of a process gas and a process fluid across the second active area.

34. A bipolar flow field plate according to claim 23, wherein the flow field structures on the first and second active areas are substantially identical.

35. A bipolar flow field plate according to claim 21, wherein the first, second and third areas are symmetrically arranged on the first active surface, and the fourth, fifth and sixth areas are symmetrically arranged on the second active surface.

36. A bipolar flow field plate according to claim 25, wherein the first, second, third, seventh and ninth areas are symmetrically arranged on the first active surface, and the fourth, fifth, sixth, eighth and tenth areas are symmetrically arranged on the second active surface.

37. An electrochemical cell stack comprising:
a plurality of electrochemical cells;
each pair of adjacent electrochemical cells co-operatively sharing a bipolar flow field plate having a first active surface and a second active surface, the first active surface serving as an anode for one of the pair of adjacent electrochemical cells and the second active surface serving a cathode for the other of the pair of adjacent electrochemical cells, and each active surface having a respective active area;
the first active surface of each bipolar flow field plate having first, second, third, seventh and ninth areas; and
the second active surface of each bipolar flow field plate having fourth, fifth, sixth, eighth and tenth area;
wherein the first, second, third, seventh and ninth areas are arranged on the first active surface so that they correspond to a 180 degree rotated image arrangement of the fourth, tenth, eighth, sixth and fifth areas, respectively, such that features present in the first, second, third, seventh and ninth areas also correspond to images of features in the fourth, tenth, eighth, sixth and fifth areas, respectively, that have been rotated 1.80 degrees.

38. An electrochemical cell stack according to claim 37, wherein each bipolar flow field plate further comprises:
a first manifold; and
the bipolar flow field plate having a first complementary active-surface feed flow aperture extending through the thickness of the bipolar flow field plate, fluidly connected to the first manifold over a portion of the second active surface and fluidly connected to the active area of the first active surface over a portion of the first active surface, such that in use at least one of a process gas and a process fluid, traveling to or from the active area of the first active surface, traverses a portion of the second active surface without being introduced to the active area of the second active surface.

39. An electrochemical cell stack according to claim 38, wherein each bipolar flow field plate further comprises:
a second manifold; and
a second complementary active-surface feed flow aperture extending through the thickness of the bipolar flow field plate, fluidly connected to the second manifold over a portion of the first-active surface and fluidly connected to the active area of the first active surface over a portion of the first active surface, such that in use at least one of a process gas and a process fluid, traveling to or from the active area of the second active surface, traverses a portion of the first active surface without being introduced to the active area of the first active surface.
